(19) United States
(12) Patent Application Publication
(10) Pub. No.: US 2024/0416459 A1
(43) Pub. Date: Dec. 19, 2024

(54) DENTAL APPLIANCE LASER OPERATIONS AND CALIBRATION

(71) Applicant: Align Technology, Inc., San Jose, CA (US)

(72) Inventors: David Turner, Durham, NC (US); James Nishimuta, Durham, NC (US); Alexey Kuts, Moscow (RU); Eduard Kopylov, Moscow (RU); Petr Budakovskiy, Moscow (RU); Alexey Kalinichenko, Cary, NC (US)

(21) Appl. No.: 18/740,343

(22) Filed: Jun. 11, 2024

Related U.S. Application Data
(60) Provisional application No. 63/521,317, filed on Jun. 15, 2023.

(51) Int. Cl. B23K 26/38; A61C 7/08; B29L 31/00

(52) U.S. Cl. CPC B23K 26/38; A61C 7/08; B29L 2031/753

(57) ABSTRACT

A method includes causing a sheet of plastic to be thermoformed over a mold to form a dental appliance and causing one or more preliminary laser operations to form a laser line in the dental appliance disposed on the mold. The dental appliance is associated with a dental arch of a user. The method further includes causing a one or more post-processing laser operations to smooth at least a portion of the laser line in the dental appliance disposed on the mold.

### RELATED APPLICATION

This application claims benefit of U.S. Provisional Application No. 63/521,317, filed Jun. 15, 2023, the contents of which are hereby incorporated by reference in their entirety.

### TECHNICAL FIELD

The technical field relates to the field of laser operations and, in particular, to dental appliance laser operations and calibration.

### BACKGROUND

Systems produce dental appliances to be used in corrective dentistry or orthodontic treatment. Dental appliances, such as palatal expanders, dental aligners, and attachment formation templates, are used to perform particular functions in accordance with respective treatment plans. For example, incremental palatal expanders can include a set of dental appliances that fit into a palate of a patient and function to expand a patient's palate according to a treatment plan. Aligners can include polymeric dental appliances that include tooth-receiving cavities to receive and reposition a patient's teeth to correct malocclusions. Dental attachment templates can include dental appliances shaped to fit to a patient's dentition and allow for the placement of attachments, e.g., bonded attachments, prefabricated attachments, etc. to the patient's dentition.

### SUMMARY

Some example implementations of the present disclosure are summarized herein.

In a first implementation, a method comprises causing a sheet of plastic to be thermoformed over a mold to form a dental appliance associated with a dental arch of a user; causing one or more preliminary laser operations to form a laser line in the dental appliance disposed on the mold; and causing a one or more post-processing laser operations to smooth at least a portion of the laser line in the dental appliance disposed on the mold.

A second implementation may further extend the first implementation. In the second implementation, the one or more preliminary laser operations comprise a cutting operation, and wherein the laser line comprises a gingival cut line of the dental appliance.

A third implementation may further extend the first or second implementations. In the third implementation, the one or more preliminary laser operations comprise multiple passes of laser energy to cut through the dental appliance.

A fourth implementation may further extend any of the first through third implementations. In the fourth implementation, the one or more preliminary laser operations comprise a marking operation, and wherein the laser line comprises an edge of a character marked in the dental appliance.

A fifth implementation may further extend any of the first through fourth implementations. In the fifth implementation, the one or more preliminary laser operations comprise a bonding operation to bond an object with a shell of the dental appliance, and wherein the laser line comprises a bonding line.

A sixth implementation may further extend any of the first through fifth implementations. In the sixth implementation, the one or more preliminary laser operations comprise one or more pulsing operations along the laser line to form a ridged profile.

A seventh implementation may further extend any of the first through sixth implementations. In the seventh implementation, the one or more post-processing laser operations have a lower laser energy compared to the one or more preliminary laser operations.

An eighth implementation may further extend any of the first through seventh implementations. In the eighth implementation, the one or more post-processing laser operations employ a modified laser focal length to reduce the peak power absorbed at the at least a portion of the laser line.

A nineth implementation may further extend any of the first through the eighth implementations. In the nineth implementation, the one or more post-processing laser operations have increased scanning speed with at least one of: a larger beam area to re-scan the at least a portion of the laser line with lower transmitted power density compared to the one or more preliminary laser operations; or a shorter duty cycle compared to the one or more preliminary laser operations.

A tenth implementation may further extend any of the first through nineth implementations. In the tenth implementation, the one or more post-processing laser operations have decreased scanning speed with lower laser output to increase pulse-to-pulse overlap and reduce peak-to-peak amplitudes of ridges along the at least a portion of the laser line compared to the one or more preliminary laser operations.

An eleventh implementation may further extend any of the first through tenth implementations. In the eleventh implementation, the one or more post-processing laser operations have offset pulses in phase to cause peak pulses to interact with the at least a portion of the laser line at an offset compared to the one or more preliminary laser operations to destructively interfere with a ridged profile along the at least a portion of the laser line.

A twelfth implementation may further extend any of the first through eleventh implementations. In the twelfth implementation, laser energy transmitted during the one or more post-processing laser operations are one or more of: directly reduced to a lower laser power or a shorter duty cycle compared to the one or more preliminary laser operations; or indirectly reduced via one or more of focus modification, targeting modification, or scanning rate modification compared to the one or more preliminary laser operations.

A thirteenth implementation may further extend any of the first through twelfth implementations. In the thirteenth implementation, the at least a portion of the laser line is one or more of a canine-premolar region of the laser line or high curvature regions of the laser line.

A fourteenth implementation may further extend any of the first through thirteenth implementations. In the fourteenth implementation, the method further comprises: determining dental appliance data of the dental appliance; providing the dental appliance data as input of a trained machine learning model; receiving, from the trained machine learning model, output associated with predictive data; and determining, based on the predictive data, laser operation data of one or more of the one or more preliminary laser operations or the one or more post-processing laser operations.

A fifteenth implementation may further extend any of the first through fourteenth implementations. In the fifteenth implementation, the trained machine learning model is trained using input of historical dental appliance data and target output comprising historical laser operation data.

A sixteenth implementation may further extend any of the first through fifteenth implementations. In the sixteenth implementation, the historical dental appliance data comprise historical images or three-dimensional topography data of historical dental appliances, wherein the historical laser operation data are associated with one or more of historical preliminary laser operations or historical post-processing laser operations.

In a seventeenth implementation, a non-transitory machine-readable storage medium having instructions stored thereon, which, when executed by a processing device, cause the processing device to perform operations comprising: causing a sheet of plastic to be thermoformed over a mold to form a dental appliance associated with a dental arch of a user; causing one or more preliminary laser operations to form a laser line in the dental appliance disposed on the mold; and causing a one or more post-processing laser operations to smooth at least a portion of the laser line in the dental appliance disposed on the mold.

In an eighteenth implementation, a dental appliance laser operation system comprising: a first laser head configured to cause one or more preliminary laser operations to form a laser line in a dental appliance, wherein the dental appliance is associated with a dental arch of a user; and a second laser head configured to cause one or more post-processing laser operations to smooth at least a portion of the laser line in the dental appliance.

A nineteenth implementation may further extend the eighteenth implementation. In the nineteenth implementation, the first laser head is configured to cause the one or more preliminary laser operations at one or more first angles, and wherein the second laser head is configured to cause the one or more post-processing laser operations at one or more second angles that are different than the one or more first angles.

A twentieth implementation may further extend the eighteenth or nineteenth implementations. In the twentieth implementation, the first laser head has first dedicated energy output properties, and the second laser head has second dedicated energy output properties that are different from the first dedicated energy output properties, wherein the second laser head is configured to cause the one or more post-processing laser operations at one or more of a modified power output, modified focus, or modified wavelength compared to the one or more preliminary laser operations.

A twenty-first implementation may further extend the any of the eighteenth through twentieth implementations. In the twenty-first implementation, the first laser head has first dedicated energy output properties, and the second laser head has second dedicated energy output properties that are different from the first dedicated energy output properties, wherein the second laser head is configured to cause the one or more post-processing laser operations at a continuous wave.

A twenty-second implementation may further extend the any of the eighteenth through twenty-first implementations. In the twenty-second implementation, the first laser head and the second laser head are configured to apply laser energy to the at least a portion of the laser line at opposing angles to alter cutline ridges to be a cross-hatched or three-dimensional ridged topography.

In a twenty-third implementation, a method comprises: causing, via a dental appliance laser operation system, one or more laser operations to provide a laser line on a material; identifying image data comprising one or more images of the laser line on the material; and calibrating, based on the image data, the dental appliance laser operation system.

A twenty-fourth implementation may further extend the twenty-third implementation. In the twenty-fourth implementation, the material is a paper, and wherein the one or more laser operations to form the laser line cause a shape to be cut into the paper.

A twenty-fifth implementation may further extend the twenty-third or twenty-fourth implementations. In the twenty-fifth implementation, the one or more images are captured via an imaging device, wherein the image data further comprises a distance between the imaging device and the material and a resolution of the imaging device.

A twenty-sixth implementation may further extend any of the twenty-third through twenty-fifth implementations. In the twenty-sixth implementation, the one or more laser operations to provide the laser line cause formation of a shape comprising one or more geometric properties.

A twenty-seventh implementation may further extend any of the twenty-third through twenty-sixth implementations. In the twenty-seventh implementation, the calibrating comprises: determining the one or more geometric properties of the shape formed on the material; determining offset data associated with differences between at least one of the one or more geometric properties and one or more threshold geometric values; and causing the dental appliance laser operation system to be adjusted based on the offset data.

A twenty-eighth implementation may further extend any of the twenty-third through twenty-seventh implementations. In the twenty-eighth implementation, the one or more laser operations comprise one or more of dental appliance trimming operations or dental appliance marking operations.

A twenty-nineth implementation may further extend any of the twenty-third through twenty-eighth implementations. In the twenty-nineth implementation, the calibrating of the dental appliance laser operation system comprises adjusting one or more of: a plate actuator configured to move a trimming plate of the dental appliance laser operation system; a mirror actuator configured to move a mirror of the dental appliance laser operation system; or a lens actuator configured to move a lens of the dental appliance laser operation system.

In a thirtieth implementation, a non-transitory machine-readable storage medium having instructions stored thereon, which, when executed by a processing device, cause the processing device to perform one or more of the proceeding implementations.

In a thirty-first implementation, a system comprises: a memory; and a processing device coupled to the memory, the processing device to perform one or more of the proceeding implementations.

### BRIEF DESCRIPTION OF THE DRAWINGS

The present disclosure is illustrated by way of example, and not by way of limitation, in the figures of the accompanying drawings.

FIG. 1 is a block diagram illustrating an exemplary system architecture, according to certain embodiments.

FIGS. 2A-J illustrate dental appliances that have undergone one or more laser operations, according to certain embodiments.

FIGS. 3A-I illustrate laser operation calibration, according to certain embodiments.

FIG. 4A is an example data set generator to create data sets for a machine learning model, according to certain embodiments.

FIG. 4B is a block diagram illustrating determining predictive data, according to certain embodiments.

FIGS. 5A-E are flow diagrams of methods associated with dental appliance laser operations, according to certain embodiments.

FIG. 6 illustrates a block diagram of an example computing device, according to certain embodiments.

FIG. 7A illustrates a tooth repositioning appliance, according to certain embodiments.

FIG. 7B illustrates a tooth repositioning system, according to certain embodiments.

FIG. 7C illustrates a method of orthodontic treatment using a plurality of appliances, according to certain embodiments.

FIG. 8 illustrates a method for designing an orthodontic appliance, according to certain embodiments.

FIG. 9 illustrates a method for digitally planning an orthodontic treatment, according to certain embodiments.

### DETAILED DESCRIPTION

Described herein are technologies related to a dental appliance laser operations and calibration (e.g., laser cutline smoothing for dental appliances, focus calibration for laser trimming, etc.).

Manufacturing systems are used to produce products. Some manufacturing systems directly produce products (e.g., direct fabrication, three-dimensional printing). For example, some dental appliance systems directly form dental appliances. Some manufacturing systems use molds to produce products. For example, some dental appliance systems use molds (e.g., of jaws, associated with teeth of a user, associated with a dental arch of a user, etc.) to form dental appliances.

A dental appliance may include one or more incremental palatal expanders, orthodontic aligners (e.g., dental appliances with or without mandibular advancement structures and/or other structures), sleep apnea treatment devices, dental attachment templates, attachment formation templates (e.g., appliances used to place attachments that engage with attachment wells and/or other structures in aligners to exert repositioning forces on a patient's dentition) that include regions that include pre-fabricated (e.g., 3D printed) attachments, and/or other dental appliances.

A sheet of plastic may be thermoformed on a mold and then a dental appliance may be cut (e.g., via a laser operation) from the sheet of plastic. Conventionally, laser operations can produce stress concentration points (e.g., stress risers) along a laser cut edge of an item. An item cut with a laser operation may have a sawtooth or ridged profile due to high-rate pulsing of the laser as the laser moves along the cutting profile. The discontinuous cutline profile (e.g., sharp peaks and valleys) may be the site of crack initiation during use of the item. The discontinuous cutline profile may cause the dental appliances to be painful for users to use.

A laser system may perform a repeatable cut of material of the dental appliance by pulsing the laser with a frequency and scanning rate that are optimized for the rapid automation step and other material factors. The cut edge (e.g., via the preliminary laser operations) is different responsive to modifying the laser pulse power, pulse duration, frequency, and/or laser translation speed (scanning speed). Conventional modifications to these parameters such as lower pulse power or slower scanning speed may have an adverse impact to the quality of the resultant dental appliance.

Conventionally, a mechanical milling operation (e.g., a 5-axis mechanical milling operation, 5-axis CNC milling) is used to mill the cutline of the dental appliance during fabrication. The mechanical milling operation has reduced cycle time, additional particulate generation, burr generation which requires polishing (e.g., manual polishing, tumbling with abrasive media, etc.), and increased manufacturing cost due to consumables.

Laser operation systems may have errors in desired laser cut lines and actual laser cut lines. Conventionally, to calibrate laser operation systems, manual operations may be performed. For example, a laser line may be formed and then the laser line may be manually measured. The laser operation system is then adjusted based on the manual measurements. This takes an increased amount of time, may generate faulty products due to user error, and reduces yield.

Items to be cut may have different thicknesses (e.g., from different angles, at different features of the item, etc.). If not enough energy is used, a laser operation may not cut through the item causing additional operations to be performed and/or the item to be discarded. If too much energy is used, a laser operation may cut through the item and the mold on which the item is disposed, mixing the materials of the item and the mold. This can cause unintended material physical characteristics and/or discoloration. Laser cutting generates heat to cut the item and interaction of the item with the heat can change the characteristics of the item (e.g., become more brittle, etc.). The laser may change the characteristics of the edge of the cut material.

Embodiments of the devices, systems, components, and methods described herein address at least some of the above-described deficiencies of conventional systems.

In some embodiments, a processing device causes a sheet of plastic to be thermoformed over a mold to form a dental appliance associated with a dental arch of a user. The processing device causes preliminary laser operations to form a laser line in the dental appliance disposed on the mold and causes post-processing laser operations to smooth at least a portion of the laser line in the dental appliance disposed on the mold. In some embodiments, the preliminary laser operations and the post-processing laser operations are performed sequentially (e.g., by the same laser head, by different laser heads). In some embodiments, the preliminary laser operations and the post-processing laser operations are performed in parallel (e.g., by different laser heads).

In some embodiments, the preliminary laser operations cut through the dental appliance (e.g., form a cutline) and the post-processing laser operations smooth at least a portion of the cutline. In some embodiments, the preliminary laser operations mark (e.g., etch characters) into the dental appliance and the post-processing laser operations smooth at least a portion of the edges of the markings. In some embodiments, the preliminary laser operations bond a shell of the dental appliance to an object and the post-processing laser operations smooth at least a portion of the bonding line.

In some embodiments, a processing device causes, via a dental appliance laser system, one or more laser operations (e.g., cutting operation, marking operation, post-processing operation, etc.) to provide a laser line on a material. In some embodiments, the material is a paper (e.g., substantially black paper). In some embodiments, the material is a metal (e.g., substantially black anodized aluminum sample). In some embodiments, the material is a dental appliance. The processing device identifies images of the laser line on the material (e.g., during the laser operations, after the laser operations). The processing device calibrates the dental appliance laser system based on the images, the dental appliance laser system. The calibration may include adjusting (e.g., via an actuator, via a motor) one or more of a trimming plate (e.g., on which the mold and the dental appliance are located), one or more mirrors (e.g., that orient the laser), and/or a lens (e.g., that adjusts the focus of the laser).

Aspects of the present disclosure result in technological advantages compared to conventional systems. The present disclosure may produce a dental appliance that has a smoother edge without manual milling and polishing operations compared to conventional solutions. This reduces discomfort to the user, reduces potential crack sites, decreases the amount of time to produce a dental appliance, increases yield, reduces amount of faulty dental appliances, and reduces particles. The present disclosure may calibrate a laser operation system without manual measurements which reduces amount of time of calibration, generates better products, and increases yield compared to conventional solutions. The present disclosure may provide a more accurate amount of energy to form lasers to be more likely to cut through the dental appliance without cutting into the mold compared to conventional solutions. This reduces material mixing, improves material physical characteristics, and provides a better edge of the dental appliance compared to conventional solutions.

Although some embodiments of the present disclosure describe dental appliances and laser operations of dental appliances, in other embodiments, other types of objects may be formed and other processes may be performed by the methods of the present disclosure (e.g., laser marking and trimming processes for orthodontic appliances, industrial laser marking and cutting, etc.).

Although some embodiments of the present disclosure describe laser cutting products, in other embodiments, other types of operations may be performed by the present disclosure, such as laser marking, laser bonding, etc.

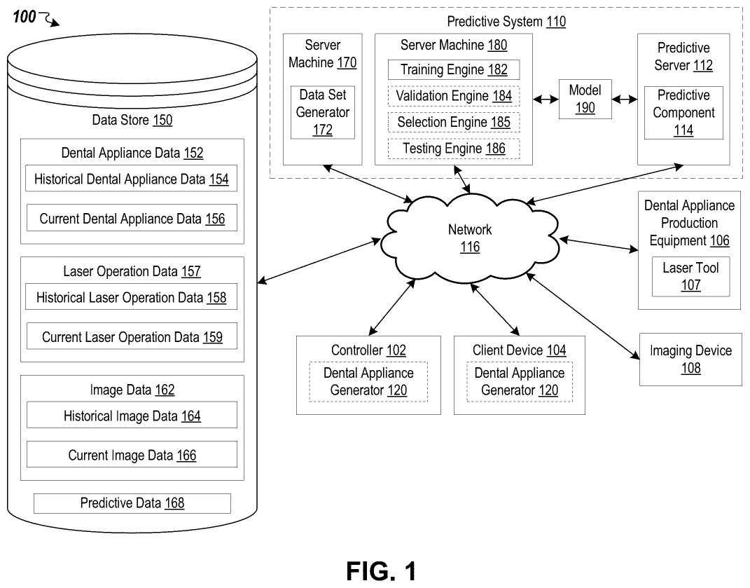

FIG. 1 is a block diagram illustrating an exemplary system architecture of system 100, according to certain embodiments. The system 100 may perform one or more processes associated with mold and/or dental appliance production. For example, system 100 may perform mold design, mold formation, mold identification, dental appliance production, laser operations, dental appliance marking, dental appliance trimming, and/or the like. In some embodiments, processes associated with mold and/or dental appliance production are controlled by a controller 102 or a client device 104.

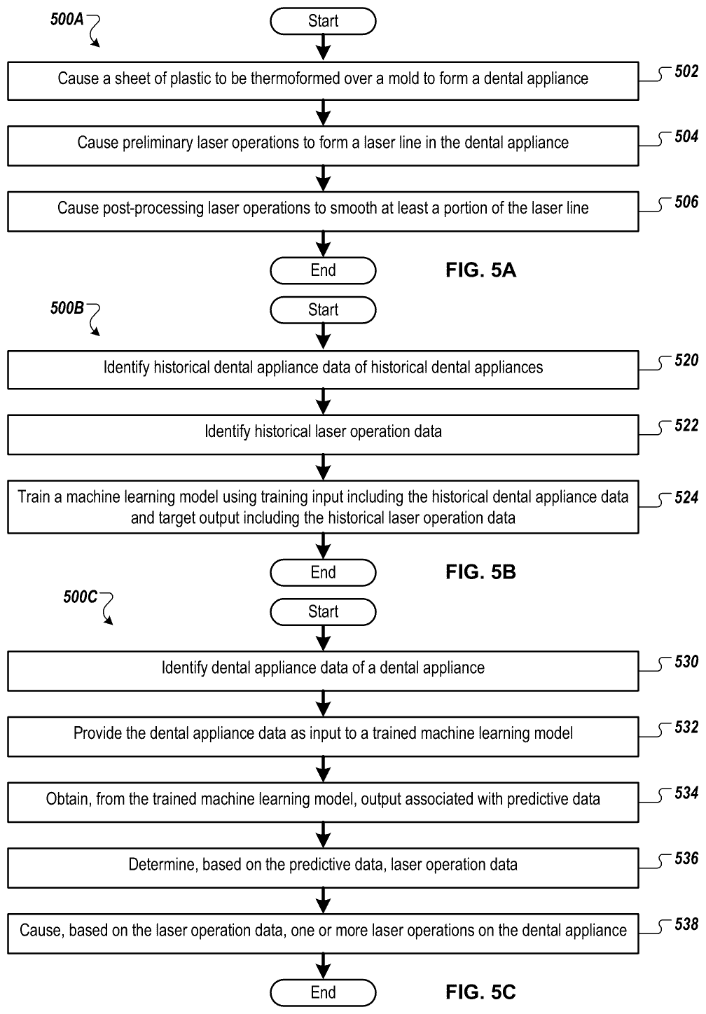

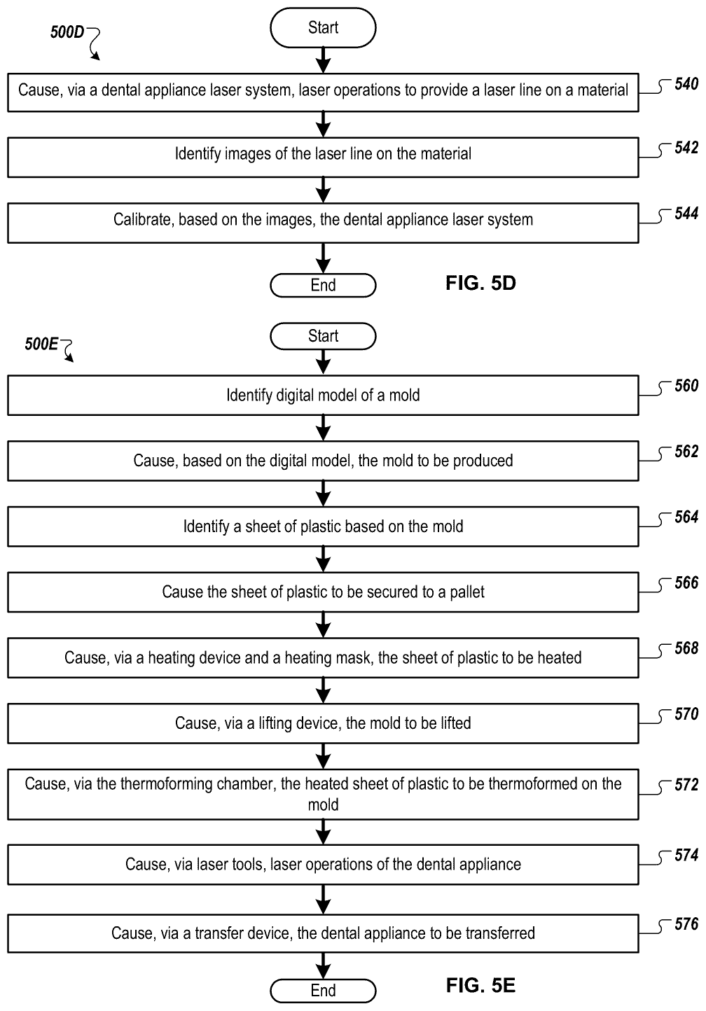

In some embodiments, controller 102 and/or client device 104 may perform dental appliance production operations, such as laser operations (e.g., laser marking, laser etching, trimming, smoothing, etc.) associated with dental appliances (e.g., see FIGS. 5A-E), calibration (e.g., of laser tool 107), etc. In some embodiments, controller 102 and/or client device 104 may perform mold and/or dental appliance production (e.g., see FIG. 5E).

The system 100 includes a controller 102, a client device 104, dental appliance production equipment 106, imaging device 108, predictive server 112, and data store 150. Dental appliance production equipment 106 may include laser tools 107. The predictive server 112 may be part of a predictive system 110. The predictive system 110 may further include server machines 170 and 180.

The controller 102, client device 104, dental appliance production equipment 106, imaging device 108, predictive server 112, data store 150, server machine 170, and server machine 180 may be coupled to each other via a network 116. In some embodiments, network 116 is a public network that provides client device 104 with access to the predictive server 112, data store 150, and other publically available computing devices. In some embodiments, network 116 is a private network that provides controller 102 access to the dental appliance production equipment 106, imaging device 108, data store 150, and other privately available computing devices and that provides client device 104 access to the predictive server 112, data store 150, and other privately available computing devices. Network 116 may include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

The client device 104 may include a computing device such as a personal computer (PC), desktop computer, laptop, mobile phone, smart phone, tablet computer, netbook computer, etc. The client device 104 may include a dental appliance generator 120. Dental appliance generator 120 may receive user input (e.g., via a graphic user interface (GUI) displayed via the client device 104) of a mold to be generated and/or a dental appliance to be formed using a mold. In some embodiments, the dental appliance generator 120 transmits data to the predictive system 110, receives output (e.g., predictive data 168) from the predictive system 110, and/or causes the mold and/or dental appliance to be generated. Client device 104 may include an operating system that allows users to one or more of generate, view, or edit data. In some embodiments, the dental appliance generator 120 may cause a mold and/or dental appliance to be generated.

The controller 102, predictive server 112, server machine 170, and server machine 180 may each include one or more computing devices such as a rackmount server, a router computer, a server computer, a PC, a mainframe computer, a laptop computer, a tablet computer, a desktop computer, graphics processing unit (GPU), accelerator application-specific integrated circuit (ASIC) (e.g., tensor processing unit (TPU)), etc.

The controller 102 and/or client device 104 may include a dental appliance generator 120. The dental appliance generator 120 may perform processes associated with mold and/or dental appliance production (e.g., FIGS. 5A-5E). For example, dental appliance generator 120 may receive data and store the data in the data store 150. Predictive system 110 may use at least a portion of the data to determine predictive data 168.

The predictive server 112 may include a predictive component 114. In some embodiments, the predictive component 114 may retrieve data from data store 150 and generate output (e.g., predictive data 168) for production of molds and/or dental appliances. In some embodiments, the predictive component 114 may use a trained machine learning model 190 to determine the output for producing the molds and/or dental appliances. The trained machine learning model 190 may be trained using data to learn key process and hardware parameters.

Data store 150 may be memory (e.g., random access memory), a drive (e.g., a hard drive, a flash drive), a database system, or another type of component or device capable of storing data. Data store 150 may include multiple storage components (e.g., multiple drives or multiple databases) that may span multiple computing devices (e.g., multiple server computers).

The data store 150 may store one or more of dental appliance data 152 (e.g., historical dental appliance data 154, current dental appliance data 156, etc.), laser operation data 157 (e.g., historical laser operation data 158, current laser operation data 159), image data 162 (e.g., historical image data 164, current image data 166, etc.), predictive data 168, etc.

Dental appliance data 152 may include geometry of each dental appliance, physical properties of each dental appliance (e.g., thickness, angles, type of material, etc.), location of each dental appliance, clearance between dental appliances, etc. The dental appliance data 152 may be determined based on model data (e.g., of dental appliances) and/or image data (e.g., of the dental appliances). Dental appliance data 152 may be based on model data (e.g., digital models) that is associated with a mold and/or dental appliance. The model data may be associated with the current dental arch of the user or may be associated with a future dental arch of the user (e.g., after using a stage of a dental arch). The model data may be three-dimensional (3D) model data associated with dental appliances.

Laser operation data 157 may include preliminary laser operation data associated with preliminary laser operations (e.g., cutting operations, marking operations, bonding operations, pulsing operations, etc.), post-processing laser operation data associated with post-processing laser operations (e.g., smoothing operations), focus data, targeting data, scanning rate data (e.g., scanning speed data, cycle time data, etc.), laser power data (e.g., laser energy data, laser output data, transmitted power data, beam size data), peak-to-peak amplitudes, ridges, offset data, number of laser operation passes, etc. In some embodiments, the laser operation data includes laser parameters (e.g., marking parameters, trimming parameters). Laser parameters may include one or more of power data, frequency data, pitch data, resolution data, focal data, velocity data, etc. Laser parameters may be used by dental appliance production equipment 106 to produce (e.g., mark, trim, bond, perform laser operations) dental appliances.

Image data 162 may include one or more of images of a laser line in the dental appliance produced by laser operations, distance of the imaging device 108 from the laser line, focus of the imaging device 108 at the laser line, etc. Image data 169 (e.g., from imaging device 108) may be of a mold and/or dental appliance before, during (e.g., in real-time), and/or after dental appliance production operations (e.g., laser operations, marking, trimming, bonding, etc.).

Predictive data 168 may include predictive laser operation data (e.g., focus, target, scanning rate, laser power, offset, etc.) based on the dental appliance data 152.

In some embodiments, the data store 150 includes marking data. Marking data may include one or more of characters, alphanumeric characters, segments of characters, etc.

In some embodiments, the data store 150 includes sensor data. For example, sensor data may include temperature data associated with the dental appliance (e.g., temperature of the dental appliance).

In some embodiments, the data store 150 includes performance data. For example, performance data may include an indication of a thickness, intensity, blurriness, legibility, illegibility, and/or the like of the laser operation (e.g., etching, marking, trimming, etc.) of the dental appliance resulting from the laser operation. A thickness may be the thickness of the segment etched via the laser operation. The intensity may be a depth (e.g., into the dental appliance) of the segment etched via the laser operation. The blurriness may be associated with the edges of the laser marking (e.g., whether the edges are a straight or pixelated). Legibility or illegibility may refer to whether a person and/or machine can correctly read the laser marking (e.g., the alphanumeric characters of the laser marking).

In some embodiments, the client device 104 may store data in the data store 150 and the predictive server 112 may retrieve the data from the data store 150. In some embodiments, the predictive server 112 may store output (e.g., predictive data 168) of the trained machine learning model 190 in the data store 150 and the client device 104 may retrieve the output from the data store 150.

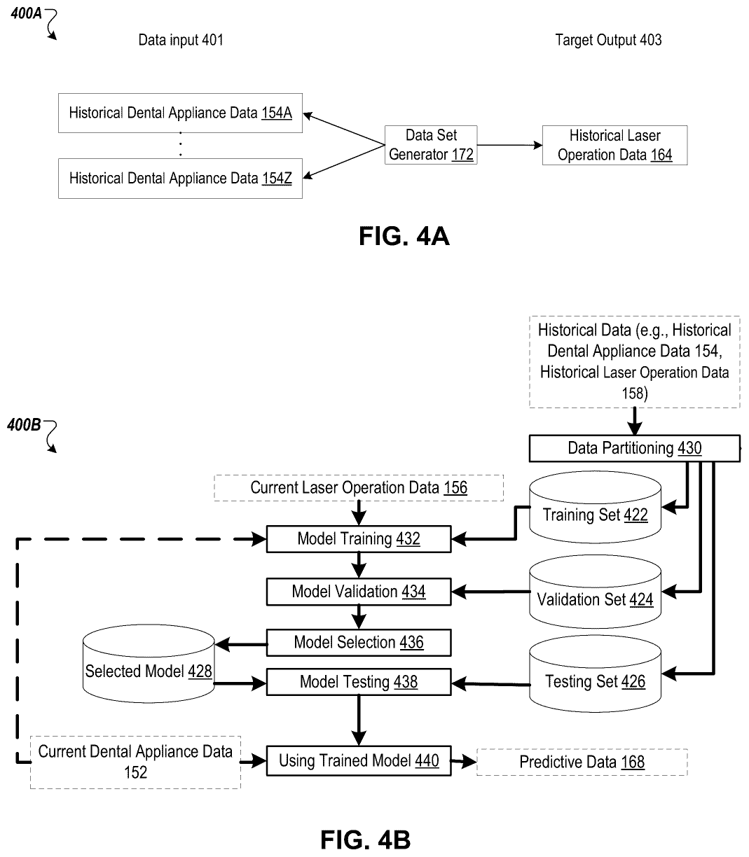

In some embodiments, predictive system 110 further includes server machine 170 and server machine 180. Server machine 170 includes a data set generator 172 that is capable of generating data sets (e.g., a set of data inputs, a set of data inputs and a set of target outputs) to train, validate, and/or test a machine learning model 190. Some operations of data set generator 172 are described in detail below with respect to FIG. 4A. In some embodiments, the data set generator 172 may partition data into a training set (e.g., sixty percent of the data), a validating set (e.g., twenty percent of the data), and a testing set (e.g., twenty percent of the data). In some embodiments, the predictive system 110 (e.g., via predictive component 114) generates multiple sets of features. For example, a first set of features may be a first set of data that correspond to each of the data sets (e.g., training set, validation set, and testing set) and a second set of features may be a second set of types of data that correspond to each of the data sets.

Server machine 180 includes a training engine 182, a validation engine 184, selection engine, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a machine learning model 190 using one or more sets of features associated with the training set from data set generator 172. The training engine 182 may generate multiple trained machine learning models 190, where each trained machine learning model 190 corresponds to a distinct set of features of the training set. For example, a first trained machine learning model may have been trained using all features (e.g., X1-X5), a second trained machine learning model may have been trained using a first subset of the features (e.g., X1, X2, X4), and a third trained machine learning model may have been trained using a second subset of the features (e.g., X1, X3, X4, and X5) that may partially overlap the first subset of features.

The validation engine 184 may be capable of validating a trained machine learning model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained machine learning models 190 based on the corresponding sets of features of the validation set. The validation engine 184 may discard trained machine learning models 190 that have an accuracy that does not meet a threshold accuracy. In some embodiments, the selection engine 185 may be capable of selecting one or more trained machine learning models 190 that have an accuracy that meets a threshold accuracy. In some embodiments, the selection engine 185 may be capable of selecting the trained machine learning model 190 that has the highest accuracy of the trained machine learning models 190.

The testing engine 186 may be capable of testing a trained machine learning model 190 using a corresponding set of features of a testing set from data set generator 172. For example, a first trained machine learning model 190 that was trained using a first set of features of the training set may be tested using the first set of features of the testing set. The testing engine 186 may determine a trained machine learning model 190 that has the highest accuracy of all of the trained machine learning models based on the testing sets.

The machine learning model 190 may refer to the model artifact that is created by the training engine 182 using a training set that includes data inputs and, in some embodiments, corresponding target outputs (correct answers for respective training inputs). Patterns in the data sets can be found that cluster the data input and/or map the data input to the target output (the correct answer), and the machine learning model 190 is provided mappings that captures these patterns. The machine learning model 190 may use one or more of linear regression, random forest, neural network (e.g., artificial neural network), etc.

Predictive component 114 may provide current data to the trained machine learning model 190 and may run the trained machine learning model 190 on the input to obtain one or more outputs. The predictive component 114 may be capable of determining (e.g., extracting) predictive data 168 associated with producing dental appliances from the output of the trained machine learning model 190 and may determine (e.g., extract) confidence data from the output that indicates a level of confidence that the predictive data 168 corresponds to current data. The predictive component 114 or dental appliance generator 120 may use the confidence data to decide whether to cause a mold or dental appliance to be produced and/or to cause a corrective action to be performed based on the predictive data 168. For example, responsive to determining confidence data that does not meet a threshold amount, the dental appliance generator 120 may cause the dental appliance to not be produced.

The confidence data may include or indicate a level of confidence that the predictive data 168 corresponds to the current data. In one example, the level of confidence is a real number between 0 and 1 inclusive, where 0 indicates no confidence that the predictive data 168 corresponds to the current data and 1 indicates absolute confidence that the predictive data 168 corresponds to the current data. In some embodiments, the system 100 may use predictive system 110 to determine predictive data 168 instead of performing manual operations. In some embodiments, responsive to the confidence data indicating a level of confidence that is below a threshold level, the system 100 may cause a corrective action of providing an alert to not use the dental appliance, re-etch the dental appliance, stop producing dental appliances, inspect the equipment, to manually inspect the dental appliance, to update the manufacturing parameters, etc. Responsive to the confidence data indicating a level of confidence below a threshold level for a predetermined number of instances (e.g., percentage of instances, frequency of instances, total number of instances, etc.) the predictive component 114 may cause the trained machine learning model 190 to be re-trained (e.g., based on current data).

For purpose of illustration, rather than limitation, aspects of the disclosure describe the training of a machine learning model using historical data and inputting current data into the trained machine learning model to determine predictive data 168. In other implementations, a heuristic model or rule-based model is used to determine predictive data 168 (e.g., without using a trained machine learning model). Predictive component 114 may monitor data. Any of the information described with respect to data inputs 401 of FIG. 4A may be monitored or otherwise used in the heuristic or rule-based model.

In some embodiments, the functions of controller 102, client device 104, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, controller 102 and client device 104 may be integrated into a single machine.

In general, functions described in one embodiment as being performed by controller 102, client device 104, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine whether to cause a mold or dental appliance to be produced or performance of a corrective action based on the predictive data 168. In another example, client device 104 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Although embodiments of the disclosure are discussed in terms of determining predictive data 168 based on dental appliance data 152 to produce molds and/or dental appliances or to perform a corrective action in dental appliance production, embodiments may also be generally applied to determining predictive data to perform an action.

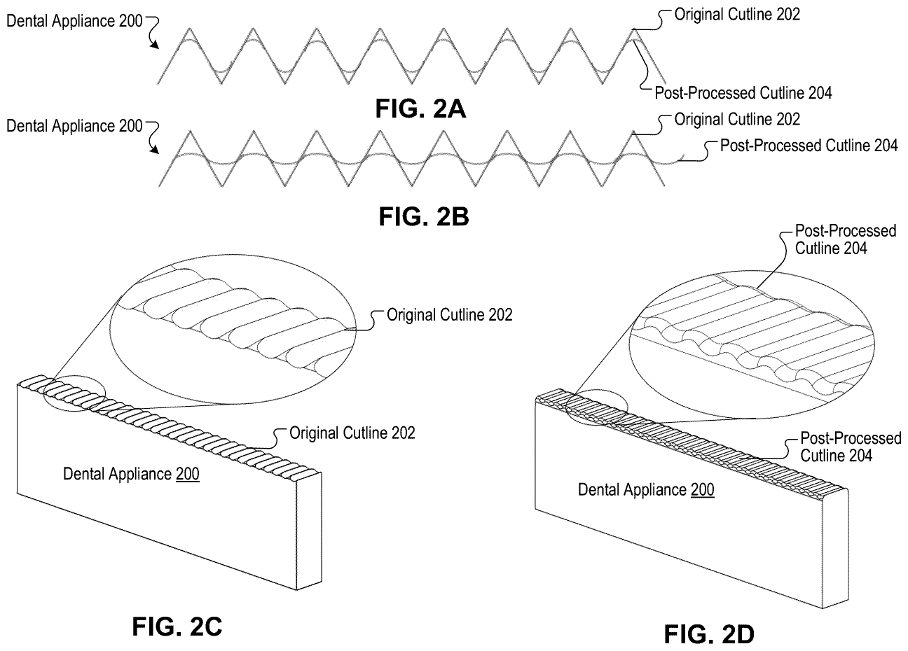

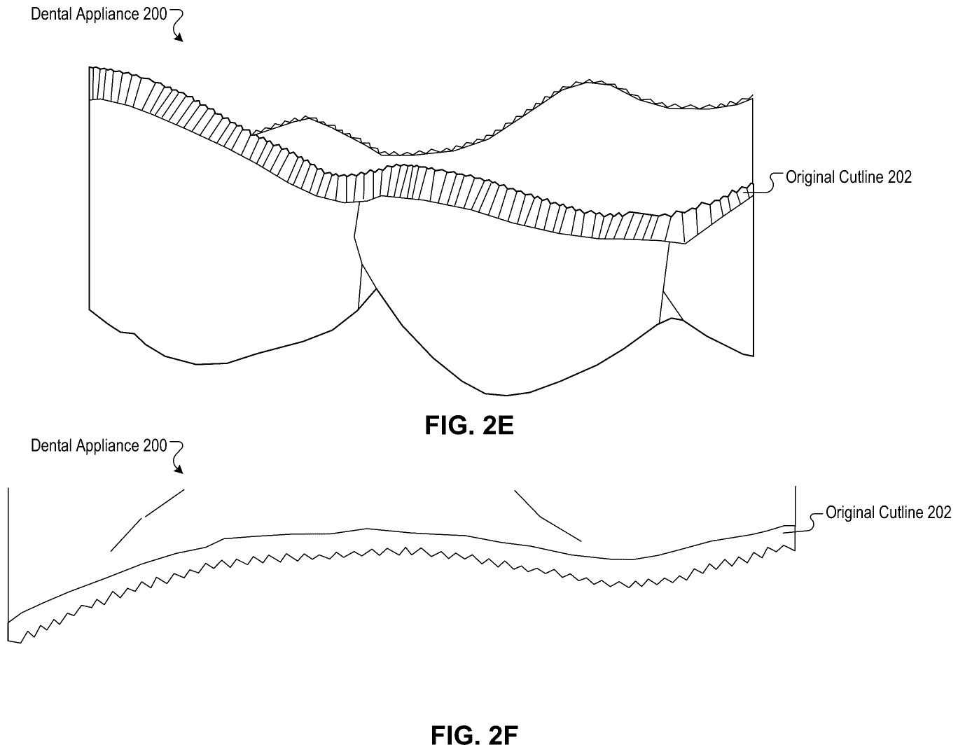

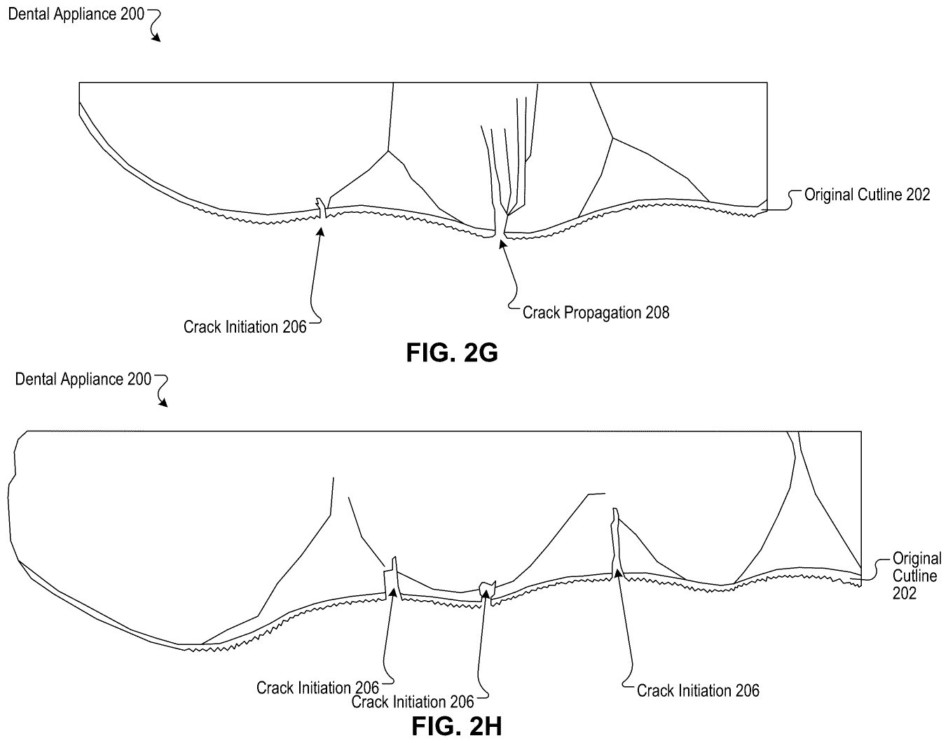

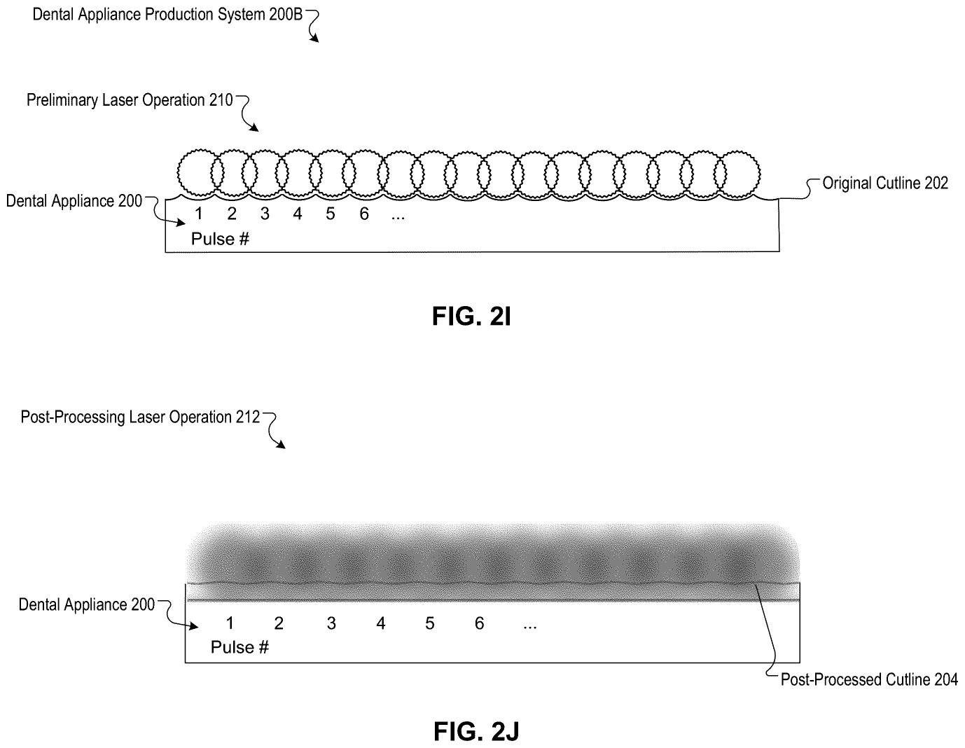

FIGS. 2A-J illustrate dental appliances 200 that have undergone one or more laser operations, according to certain embodiments.

Dental appliances 200 may include aligners (e.g., clear aligners), retainers, etc., which may be a thermoformed material that is cut from a mold (e.g., custom stereolithography (SLA) mold) along a pre-determined cutline in three-dimensional (3D) space. Dental appliances 200 may be made of thermoplastics and may be subjected to cyclic loading that may initiate and propagate stress cracking along discontinuous laser cutlines (e.g., of a preliminary laser operation without a post-processing laser operation).

In some embodiments, one or more preliminary laser operations are performed on a dental appliance (e.g., aligner) to cut, trim, mark, bond, etc. the dental appliance. The laser line formed by the preliminary laser operations may be rough. One or more post-processing laser operations may be performed (e.g., after the preliminary laser operations) to produce a more continuous, smooth gingival cut line on the dental appliance to yield benefits in addition to mechanical performance. Patient comfort may be improved by reducing the roughness along the edge, as the edge is in proximity to sensitive gingival and labial tissue during clinical use. Aesthetics may also be improved by reducing the ridged appearance of the cutline. A dental appliance may be used for reduced visibility of the treatment compared to other methods. A smoother cutline is less easily noticeable and display a more natural appearance when worn by patients.

A post-processing laser operation permits the existing preliminary laser operation to be used to achieve the desired through-cut of the material of the dental appliance while also allowing the addition of post-processing laser operation (e.g., a rapid low-power pass as a finishing operation) to achieve the desired material condition of the cut.

FIGS. 2A-D illustrate dental appliances 200, according to certain embodiments. FIGS. 2A-B illustrate dental appliances 200 that have an original cutline 202 and a post-processed cutline 204. FIG. 2C illustrates a dental appliance that has an original cutline 202 (e.g., unprocessed aligner cutline, as-cut rough condition). FIG. 2D illustrates a dental appliance 200 that has a post-processed cutline 204 (e.g., post-processed aligner cutline, post-processed smooth condition). Dental appliances 200 may undergo a process of laser cutline smoothing (e.g., for clear aligners) to have the post-processed cutline 204.

The post-processing laser operation may reduce stress concentration points (e.g., stress risers) along laser cut edge of the dental appliance 200 (e.g., clear aligners). Dental appliances that are cut from the mold (e.g., SLA mold) using a preliminary laser operation during dental appliance fabrication may have a sawtooth or ridged profile along original cutline 202 due to the high-rate pulsing of the laser as the laser moves along the cutting profile. The discontinuous cutline profile, which may include sharp peaks and valleys, may frequently be the site of crack initiation during use of the dental appliance. By implementing a post-processing laser operation (e.g., a secondary laser pass over the cutline with a diffuse laser, lower laser energy, and/or modified pulsing) along the laser line (e.g., laser cutline), the original cutline 202 (e.g., ridged cutline) is smoothed, leading to a reduction or elimination of crack initiation sites, material discontinuities, stress concentrations, and/or stress risers. This also provides enhanced patient comfort, improved aesthetics, and reduction of delamination of the dental appliance 200 (e.g., separation of the layers of plastic in the sheet of plastic used to form the dental appliance 200).

The preliminary laser operation may have a cut-line roughness, ridged profile, and/or a dotted-line profile. The post-processing laser operation (e.g., secondary laser operation) may remove or reduce the roughness, ridged profile, dotted-line profile, etc. The post-processing laser operation may be a more diffuse laser along substantially the same path (e.g., laser line) as the preliminary laser operation (e.g., cutting laser). This may provide more patient comfort, reduction of stress crack initiation, sealing of the layers (e.g., three layers) of the dental aligner together at an edge to minimize delamination or edge discoloration, reduce outward (e.g., buccal) flare at cutline, etc.

The post-processing laser operation may thermally post-process the rough-cut edge (e.g., original cutline 202) of a dental appliance 200 (e.g., thermoformed aligner) to improve the overall mechanical properties of a thermoformed and laser-cut dental appliance 200. The post-processing laser operation may be performed using automation with minimal impact to manufacturing cycle time or equipment modifications.

After the initial cutting (e.g., original cutline 202) of the dental appliance 200 from the mold (e.g., SLA mold) using the laser equipment (e.g., laser tool, laser head), the original cutline 202 has a rough and discontinuous profile, remnant from the pulsed high-energy laser output used to fully penetrate and cut the material of the dental appliance 200. The residual rough edge may have a sawtooth appearance and localized sharp edges which are likely sites for stress risers and crack initiation during repeated loading. The post-processing laser operation may cause the cutline edge (e.g., original cutline 202) to have a more continuous profile (e.g., prost-processed cutline 204) that has fewer stress riser sites and improved cracking behavior in high-strain regions.

The post-processing laser operation may be an application of laser energy with a modified output during a subsequent (e.g., secondary and/or tertiary) scanning pass over the same cutline path while the dental appliance is still contained on the mold (e.g., SLA mold) and positioned within the laser cutter. Since the material of the dental appliance 200 will already have been cut from the preliminary laser operation (e.g., initial pass of the laser at full power), the one or more post-processing laser operations (e.g., finishing pass(es)) may be performed using a lower laser energy than the preliminary laser operation. The modified cutline (e.g., post-processed cutline 204 may be achieved by one or more of the following:
Lower laser power; following the initial cutline path with a second pass using lower laser power (e.g., lower energy output with or without shorter pulse duration via reduced duty cycle);
Diffuse laser beam: slight out-of-focus condition, such that peak power is not absorbed at the cutline;
Adjust (e.g., increase or decrease) laser scanning rate: increased scanning speed of laser with more diffuse beam (e.g., larger spot size or beam diameter) to re-scan full cutline with lower transmitted power and/or shorter duty cycle (%); or decreased scanning speed of laser path with lower laser output power to increase the pulse-to-pulse overlap and reduce peak-to-peak amplitudes of ridges along cutline (e.g., cause larger beam (reduced power density) and/or shorter duty cycle, for example, a larger beam with an unchanged duty cycle may be used to cause a particular post-processing result); and/or
Out-of-phase pulsing: same pulsing profile, frequency, and focus as the initial cutting pass, but with pulses offset in phase so that the peak pulses interact with the cutline at an offset to destructively interfere with peaks or ridges of the initial cutline profile.

FIGS. 2E-F illustrate dental appliances 200, according to certain embodiments. In some embodiments, FIGS. 2E-F illustrate original cutlines 202 (e.g., laser cutline) on dental appliances 200 (e.g., clear aligner) after preliminary laser operations.

Original cutlines 202 (e.g., laser cutlines) of dental appliances 200 (e.g., clear aligners) may have a rough or ridged profile when the dental appliance 200 is fabricated using preliminary laser operation (e.g., via laser tool) prior to removal from the mold (e.g., SLA mold). The post-processing laser operation is configured to smooth the original cutline 202 (e.g., the profile) via automation and high-capacity manufacturing infrastructure. The laser equipment (e.g., laser tools, laser heads) may quickly make a post-processing laser operation (e.g., secondary pass) along the original cutline 202 of an already-cut dental appliance 200, using a modified energy output. The post-processing laser operation (e.g., secondary following pass of the laser) may not cut through the material of the dental appliance 200. The post-processing laser operation may raise the localized material temperature along the already-cut edge to a pre-determined softening or melt temperature for a time period sufficient to reduce or eliminate the sawtooth profile of the original cutline 202. The laser energy output during post-processing laser operations (e.g., subsequent post-processing passes) may be directly reduced (e.g., lower laser power) or indirectly reduced via focus, targeting, and/or scanning rate modifications to achieve the desired material effects.

FIGS. 2G-H illustrate dental appliances 200, according to certain embodiments. FIGS. 2G-H may illustrate dental appliances 200 (e.g., clear aligner) that have crack initiation 206 and/or crack propagation 208 from the original cutline 202 (e.g., rough laser cutline).

The original cutline 202 (e.g., laser cutline) of dental appliances 200 (e.g., without having a post-processing laser operation) may be a location of crack initiation during repeated cyclic use. Material strains caused by biting forces, forces from insertion of the dental appliance (e.g., aligner insertion forces), forces from removal of the dental aligner (e.g., aligner removal forces), and programmed tooth movement may contribute to crack formations at the original cutline 202. By reducing the sawtooth profile of the cutline (e.g., via post-processing laser operation) and normalizing the cutline into a smooth termination of the material of the dental appliance, there is a reduction in the number of stress concentrations and crack initiation sites along the cutline.

FIGS. 2I-J illustrate dental appliances 200, according to certain embodiments. FIG. 2I illustrates a dental appliance 200 that has an original cutline 202 formed by a preliminary laser operation 210 (e.g., initial cutting pass of laser tool, high energy focused laser operation). FIG. 2J illustrates a dental appliance 200 that has a post-processed cutline 204 formed by a post-processing laser operation 212 (e.g., lower energy post-processing pass of laser tool, low energy diffuse laser operation, finishing laser pass).

In some embodiments, the post-processing laser operation 212 is a diffuse beam with increased pulse-to-pulse spacing along the scanning path compared to the preliminary laser operation 210. By diffusing the beam in the post-processing laser operation 212 such that the peak energy is not absorbed at the cutline, material heating may be achieved without additional material removal.

In some embodiments, the post-processing laser operation 212 is applied to the full gingival cutline of the dental appliance 200. In some embodiments, the post-processing laser operation 212 is selectively applied in localized areas or segments (e.g., of the gingival cutline, of the aligner arch) of the dental appliance 200. In some examples, if simulation modeling shows that stresses and cracking are more likely to occur at the canine-premolar (e.g., inter-premolar (IP)) region of the dental appliance 200, a cutline post-process operation may be implemented for those regions only. In some examples, the post-processing laser operation 212 is applied to precision cuts and/or regions of the cutline with high curvature, such as where the cutline path follows a high-curvature scalloped geometry based on patient anatomy. The selective or localized post-processing laser operation 212 may reduce manufacturing cycle time for higher throughput.

Post-processing laser operations 212 may also be achieved through the addition of a second dedicated laser head within the laser cutting chamber. The additional laser could have dedicated energy output properties, such as modified power output, focus, or wavelength that are modified (e.g., optimized) for post-processing (e.g., instead of for material cutting). In some embodiments, the additional laser may be located (e.g., optimized placement) within the laser chamber to allow a unique angle of attack to the cutline of the dental appliance 200, different from the angle of attach of the primary cutting laser. By applying laser energy to the cutline at opposing angles, the cutline ridges could be altered to be a cross-hatched or 3D-ridged topography that may better protect against crack initiation at stress risers (e.g., instead of a parallel ridged profile).

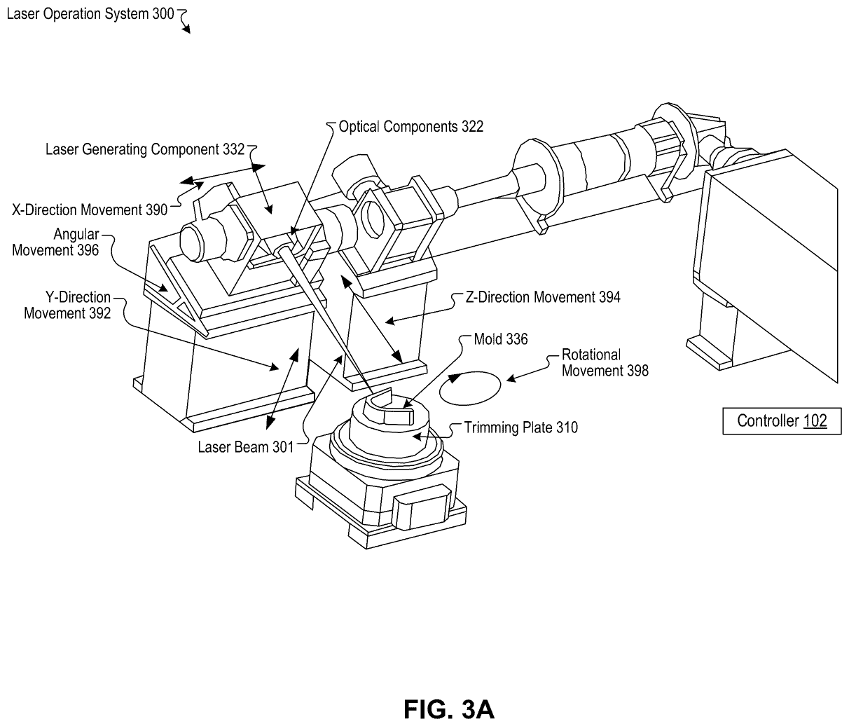

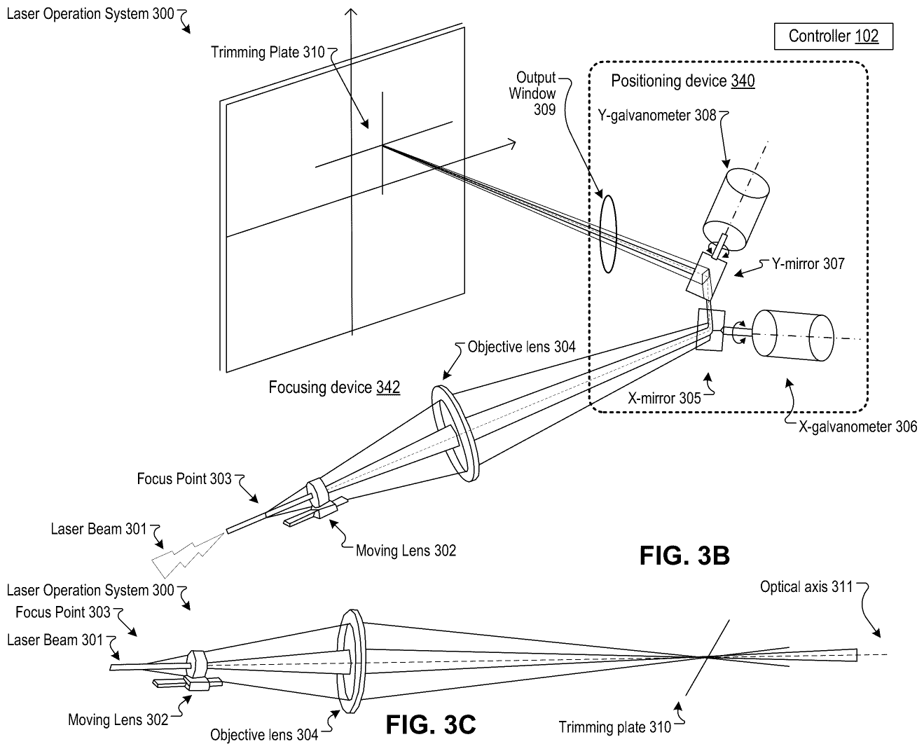

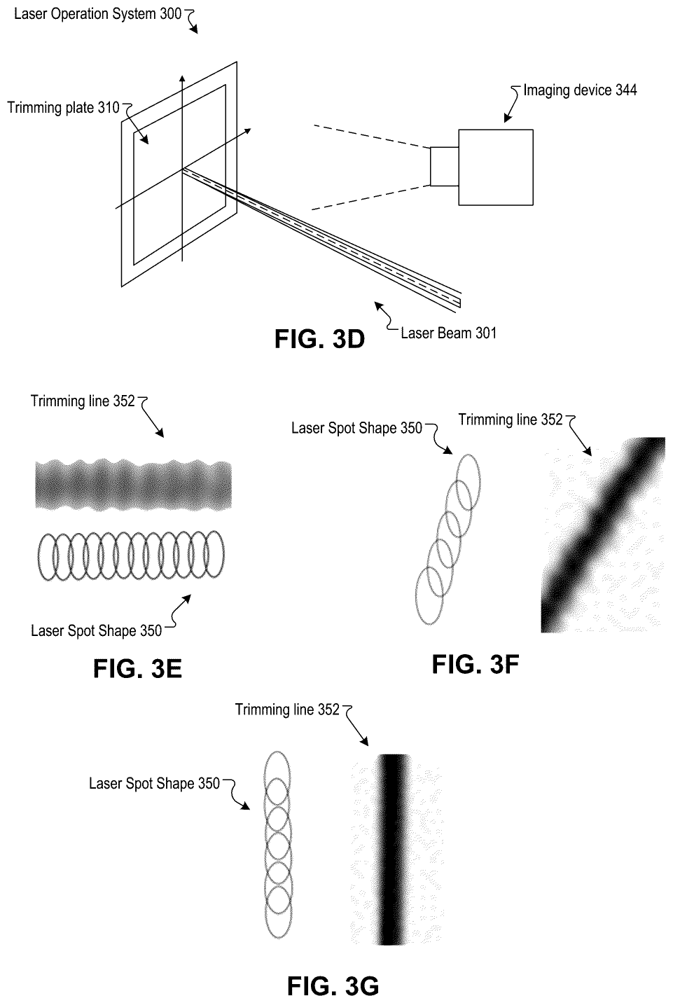

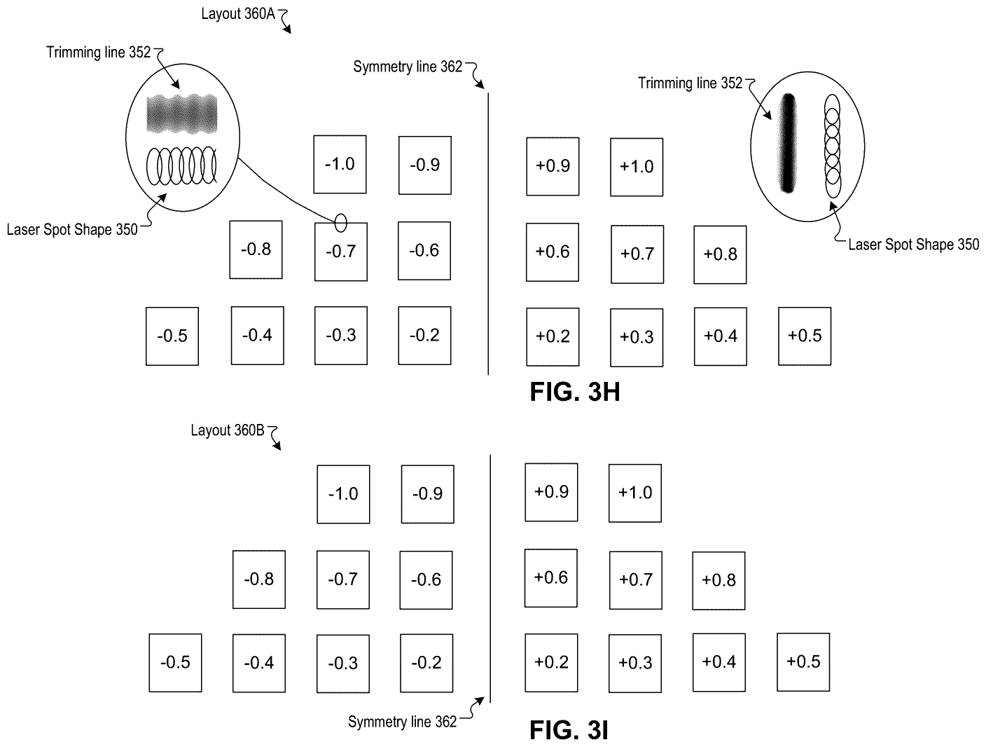

FIGS. 3A-I illustrate laser operation calibration, according to certain embodiments. FIGS. 3A-D illustrate components of laser operation systems 300 (e.g., dental appliance production equipment 106 and/or laser tool 107 of FIG. 1). FIGS. 3E-I illustrate laser operations via laser operation systems 300. Dental appliances 200 of one or more of FIGS. 2A-I may be formed by one or more of the laser operation systems 300 or laser operations of one or more of FIGS. 3A-G. Features of one or more of FIGS. 3A-I that have similar names and/or reference numbers as other features described in relation to one or more other FIGS. may have the same and/or substantially similar properties, material, components, functionality, and/or the like. Although only one laser head may be shown in some of the FIGS., a laser operation system 300 may have multiple laser heads (e.g., one for preliminary laser operations and one for post-processing laser operations, etc.).

FIG. 3A illustrates a laser operation system 300. Laser operation system 300 may include one or more laser generating components 332 (e.g., laser heads) and a controller 102. In some embodiments, controller 102 may cause a preliminary laser operation (e.g., to cut the dental appliance) along a laser line and a post-processing laser operation to smooth the laser line (e.g., cutline).

In some embodiments, controller 102 may cause, via laser operation system 300 (e.g., laser generating components 332, etc.), one or more laser operations to provide a laser line on a material (e.g., paper, metal, dental appliance, etc.). Controller 102 may identify image data including one or more images of the laser line on the material. Controller 102 may calibrate, based on the image data, the laser operation system 300 (e.g., dental appliance laser operation system).

Laser operation system 300 may undergo a method of automatic focus calibration for laser operations (e.g., laser trimming, laser marking, laser bonding, preliminary laser operation, post-processing laser operation). In some embodiments, laser operation system 300 may have automatic adjustment of dynamic moving lens of laser system that causes the laser beam to be focused on the target surface during laser operations (e.g., laser trimming, preliminary laser operations, post-processing laser operations, etc.). The deviations from optimal lens position in both directions may lead to laser spot size increase with the reduction of laser beam energy (e.g., and consequently trimming issues). In some embodiments, the laser operation system 300 may include a computer numerical control laser cutter, laser trimming, laser material processing, and/or focus calibration.

In some embodiments, a laser line is formed by consequent laser shots with fixed pulse frequency. The consequent series of overlapped laser spots with proper pulse frequency provides a continuous cutting line that melts material of a dental appliance (e.g., aligner). The laser focusing device controls the laser spot size in the work plane by position of dynamic moving lens along a laser optical axis.

In some embodiments, calibration of the laser operation system 300 is based on image processing of an image of material (e.g., black anodized aluminum sample) captured by an imaging device after a calibration test (e.g., marking or cutting the material). The test is configured to apply moving lens offset symmetrically in both directions relative to the current position. Level of asymmetry between printed drawings may be automatically estimated using intensity histogram matching and a new position of the moving lens may be calculated for optimal focus. This may provide a fast and accurate way to calibrate focus of laser machines with dynamic moving lens focus control. Focus calibration may be incorporated into calibration procedure of the laser operation machine 300 (e.g., laser trimming machine). This is faster and more accurate of conventional solutions of manual focus calibration using visual checks (e.g., manually measuring with calipers). This may be applied to all dental appliances (e.g., clear braces products) where laser operations (e.g., laser trimming) is applied.

FIG. 3A illustrates a laser operation system 300 (e.g., laser cutting system, laser marking system, laser bonding system, etc.). A sheet of plastic may be thermoformed on a mold and laser operation system 300 can be used to perform laser operations (e.g., cut, trim, post-process, smooth mark, bond, etc.) the thermoformed sheet of plastic to form a dental appliance. In some examples, the laser operation system 300 cuts the thermoformed sheet of plastic to cut away extra material and the laser operation system 300 may smooth the cutline. The laser operation system 300 may cut the thermoformed sheet of plastic without cutting the mold to prevent mixing of the material of the mold with the material of the dental appliance (e.g., which could cause unintended material physical characteristics, discoloration, etc.). The laser operation system 300 may perform the laser operations without changing the characteristics of the material near the cut path (e.g., avoid making the material more brittle from the heat of the laser).

The laser operation system 300 may adjust the laser beam based on the thickness and angles of the material being cut. In some examples, if a portion of the material being cut is thicker, the laser may use a higher energy output to cut through the material (e.g., vaporize the material effectively). In some examples, the if the material is thinner, the laser may use a lower energy output to not change the characteristics of the edge of the cut material and to not cut through the mold.

The laser operation system 300 may include a laser generating component 332, an optical component 322, a trimming plate 310 (e.g., fixture) for holding a mold 336 with a dental appliance positioned on the mold 336, and a controller 102 configured to adjust at least one of the laser generating component 332, the optical component 322, and/or the trimming plate 310 such that a ratio of a laser energy applied to the dental appliance and a material thickness of the dental appliance is maintained within a predetermined acceptable range at each point along a cut path to cut through the dental appliance while maintaining the integrity of the support.

The laser operation system 300 may cut through a material for forming a dental appliance without cutting into a material of the mold 336 adjacent to the material of the dental appliance. In some embodiments, the laser beam 301 can cut through the material of the dental appliance, but not substantially into the material of the mold 336. The laser operation system 300 may provide a dental appliance that is cut and is not substantially mixed with material from the mold 336 and/or may allow for reuse of the mold 336.

The laser operation system 300 may allow for a dental appliance to be cut quickly without a substantial change to the characteristics of the edge of the dental appliance near the cut path made by the laser beam 301, such as the brittleness or discoloration of the dental appliance. The laser operation system 300 may cut through materials having different thicknesses that are adjacent to a mold 336. This can be accomplished by changing one or more characteristics of the laser beam 301.

Laser operation system 300 may be used to laser cut a dental appliance from a sheet of plastic that has been thermoformed over a mold 336.

Laser operation system 300 may include a laser generating component 332, optical components 322, fixture 334, and a mold 336 positioned on the trimming plate 310. The trimming plate 310 may form a platform for positioning the mold thereon and a rotating component that allows the part to mold 336 (e.g., and dental appliance) to rotate (e.g., in rotational movement 398, in a clockwise and/or counterclockwise direction when viewed from above the platform).

Controller 102 may move components of the laser operation system 300 in one or more of the x-direction movement 390, y-direction movement 392, z-direction movement 394, angular movement 396, and/or rotational movement 398. Controller 102 may cause x-direction movement 390, y-direction movement 392, z-direction movement 394, and/or angular movement 396 of the laser beam 301. Controller 102 may cause rotational movement 398 of trimming plate 310.

The laser operation system 300 includes a controller 102. The controller 102 may include a processing device and memory. Instructions may be stored in the memory and executed by the processing device to control one or more components (e.g., movement of trimming plate 310 holding the dental appliance, movement of laser generating component 332, movement of optical components 322, adjustment of characteristics of the laser beam generated by the laser generating component 332, adjustment of characteristics of a gas applied via a nozzle, and/or characteristics of suction applied via a tube).

Memory can also have data stored therein that can be used in executing instructions. Memory can be a non-transitory machine-readable medium that provides volatile or nonvolatile memory. The memory can also be removable, e.g., portable memory, or non-removable, e.g., internal memory. For example, the memory can be random access memory (RAM) or read-only memory (ROM). Memory can, for example, be dynamic random access memory (DRAM), electrically erasable programmable read-only memory (EEPROM), flash memory, phase change random access memory (PCRAM), compact-disk read-only memory (CD-ROM), a laser disk, a digital versatile disk (DVD) or other optical disk storage, and/or a magnetic medium such as magnetic cassettes, tapes, or disks, among other types of memory. Memory can be located in controller 102 and/or can be located in a memory device that is not a controller 102 but is connected to the controller 102. In some embodiments, the memory can be internal or external to a computing resource and can enable machine readable instructions to be uploaded and/or downloaded over a network, such as the Internet, or another wired or wireless connection.

With respect to the control of the laser generating component 332, the energy of the laser beam 301 can be controlled in various manners. For example, the power to the laser generating component can be adjusted to increase the energy of the beam created.

For instance, the energy to be applied to the dental appliance can be controlled within a predetermined range by modulating the power of the laser beam, adjusting an optical component 322 (e.g., one or more mirrors and/or lenses), and/or controlling the speed of the trimming plate 310 and/or laser generating component 332 relative to the trimming plate 310 based on characteristics of the dental appliance and the desired cutting path. The combination of these elements can be varied depending upon the characteristics of the laser operation system 300 and/or the characteristics of the materials being cut. In some examples, if the laser operation system 300 does not have a laser generating component 332 that is adjustable with regard to energy of the laser generating component 332, then the speed of the movement of the trimming plate 310, the laser generating component 332, and/or one or more optical components 322 can be adjusted.

An adjustment that can be made is with respect to the optical components 322 used. By changing components (e.g., switching lenses), or adjusting them (e.g., changing the focal length and/or moving the optical components 322), the energy generated by the laser generating component 332 can be changed as the energy passes through or is directed by one or more optical components 322.

These movements can be controlled by the controller 102 and/or by the executable instructions stored in memory. For example, a five-inch focal length may be used, but the focal length may be adjusted to a shorter or longer length. This focal length can be beneficial for applications such as cutting dental appliances as the focal length allows for variability and can maintain a high enough laser energy at focus to adequately vaporize the part material.

The controller 102 may include a fixture control (e.g., software and electrical and/or mechanical actuators) configured to adjust a speed of the trimming plate 310. Responsive to the controller 102 receiving data regarding the part material thickness, at multiple points along a cut path where the laser beam will cut the part, the controller 102 may adjust a speed of movement of the part past the laser beam based on the thickness data such that the ratio of the laser energy applied to the part and the part material thickness is maintained within the predetermined acceptable range. In such embodiments, the ratio can be predetermined or determined dynamically based upon thickness data and/or laser power data taken during the cutting process. The acceptable range of the ratio is based on the laser energy needed to cut through the part material without cutting into the mold, or in some instances, without cutting into the mold to such an extent as to either damage the mold or facilitate the mixing of support material with the part material.

The controller 102 can include a laser power adjustment control that receives data regarding the part material thickness, at multiple points along the cut path where the laser beam will cut the part, and adjusts a power of the laser generating component based on the thickness data such that the ratio of the laser energy applied to the part and the part material thickness is maintained within the predetermined acceptable range.

The controller 102 can include an optics control that adjusts a position of one or more of the number of optical components where the controller 102 receives data regarding the part material thickness, at multiple points along a cut path where the laser beam will cut the part, and adjusts a position of the one or more of the number of optical components based on the thickness data such that the ratio of the laser energy applied to the part and the part material thickness is maintained within the predetermined acceptable range.

A single controller 102 can be utilized to control all of the above functionalities, or these functionalities can be controlled by multiple components (e.g., processors). In some embodiments, the speed of the part at the cutting position relative to the laser beam at the cutting position can be maintained substantially constant while the part is movable in at least three axes of movement and the power of the laser beam is controlled within a given range based on information about one or more characteristics of at least one of the part material, a support, and backing material.

In some embodiments, the controller 102 for adjusting the laser energy is configured to adjust at least one of laser generating component power, laser generating component movement, optical component type, optical component movement, fixture movement, gas type, gas pressure, gas temperature, and suction such that a ratio of a laser energy applied to the part and a part material thickness is maintained within a predetermined acceptable range.

In some embodiments, the laser energy applied to the part thickness is maintained as the part moves at a constant or substantially constant feed rate. This can be beneficial in that the laser energy making the cut is generally distributed in an even manner as the laser beam progresses along the cut path, among other benefits. An example of a substantially constant feed rate can, for example, be 1000-1500 mm/sec. Another example includes using a 10.6 micron wavelength laser that can run at 5-10 W and have a constant feed rate of between 1500 and 2000 mm/sec. Such a configuration may allow for reduced brittleness at the edge of the cut path, in some applications.

In some embodiments, the laser energy applied to the part thickness is maintained by increasing the laser generating component power. This can be beneficial in instances where the speed of the movement of the fixture and/or laser beam cannot be adjusted, among other benefits.

The laser energy applied to the part thickness can be maintained by adjusting the optical component to create a stronger or weaker laser energy applied to the part, in some embodiments. This can be beneficial, for example, because movement of the optical components can be a more cost-effective approach to adjusting the laser energy than other arrangements, such as movement of the laser and/or fixture, among other benefits.

Further, in some embodiments, if the overall power of the laser is low compared to its output potential, a beam splitter can be utilized to raise the output percentage of the power generated by the laser generating component. This can allow the laser generating component to operate in a more stable range in relationship to its duty cycle, in some instances. This may increase the durability of the system by operating the laser in its mid power range (e.g., 40-60%, while delivery to the cut location may be as low as 10% due to the splitting of the beam), in some applications. Another benefit of this arrangement can be the reduction of laser pulsing (i.e., a fluctuation in laser energy) because the laser in not operating at a low power, in some instances.

Additionally, the use of a lower energy with respect to the cut location can reduce the presence of several phenomena that cause brittleness. For example, reforming the heated part material (i.e., a region next to the edge of the cut that is smooth and shiny due to melting and cooling), mounding or lipping (i.e., a region next to the edge of the cut that forms a raised smooth and shiny beaded edge), and recasting (i.e., an edge that is rough and has remnants of the molten material as it is blown off its resting point by gas from the gas nozzle, if used).

Electrical and/or mechanical actuators can be used to move one component with respect to another component of the laser operation system 300. For example, controller 102 can be used to move the laser generating component 332, optical component 322, and gas nozzle closer or farther with respect to the platform and thereby closer to or farther from the mold 336. Such movements can change the characteristics of the laser beam generated, how the optics interact with the beam generated, and the gas applied. In some embodiments, the nozzle, optical component 322, and laser generating component 332 can each be moved independently with respect to each other.

Controller 102 can control a mechanical actuator that moves the trimming plate 310 in one or more directions. In some examples, the mechanical actuator can move the dental appliance horizontally with respect to the laser generating component 332 and can also rotate the trimming plate 310 clockwise and/or counterclockwise. In some embodiments, the combination of the movements allows the trimming plate 310 to be moved in five axes of motion with respect to the laser generating component 332.

In one or more embodiments, the trimming plate 310 for handling the dental appliance can, for example, include a robot suction and/or pincher mechanism to secure and/or move the mold 336 and/or dental appliance during the laser cutting process.

FIG. 3B illustrates a laser operation system 300, according to certain embodiments. One or more lasers are used for manufacturing of dental appliances (e.g., aligners and retainers) using laser operations (e.g., laser cutting processing) to achieve high processing velocities, high positioning repeatability, and small laser spot size.

A laser beam 301 is moved to melt material of the dental appliance along a cutting line on a trimming plate 310 (e.g., fixture). Controller 102 (e.g., laser control system) is used to control the movement and focusing of the laser beam 301. Controller 102 may control one or more of positioning device 340, focusing device 342, X-mirror 305 via X-galvanometer 306, Y-mirror 307 via Y-galvanometer 308, trimming plate 310 via a trimming plate actuator (e.g., configured to rotate the trimming plate 310), and/or objective lens 304 via a lens actuator. The positioning device 340 may include the X-mirror 305 (e.g., rotatable mirror) driven by X-galvanometer 306 and the Y-mirror 307 (e.g., rotatable mirror) driven by Y-galvanometer 308. The focusing device 342 may include a moving lens 302 (e.g., high-speed dynamic expansion lens) and the objective lens 304 located along an optical axis before the positioning device. The focusing device 342 may control the laser spot size in the work plane (e.g., trimming plate 310) and the positioning device 340 may control the positions of the laser spot in the work plane (e.g., trimming plate 310).

FIG. 3C illustrates a laser operation system 300 (e.g., including laser focus device), according to certain embodiments. Features of FIG. 3C that include similar names and/or reference numbers as other FIGS. may include the same or substantially similar properties, material, functionality, components, etc.

Laser beam 301 after transmittance through focusing device 342 (e.g., objective lens 304) may be a cone and may fall upon a trimming plate 310 (e.g., working plate) at an angle. For simplification, the positioning device 340 is omitted in FIG. 3C to illustrate an angle between the trimming plate 310 and optical axis 311.

The intersection of cone (e.g., laser beam 301 after objective lens 304) and plane (e.g., trimming plate 310) is an oval so a laser beam spot may have a general ovaloid shape. The laser trimming line may be formed by consequent laser shots with fixed pulse frequency. The consequent series of overlapped laser spots with proper pulse frequency may provide a substantially continuous line (e.g., ridges, sawtooth) on the pattern. Depending on laser line direction, the width and continuity of the laser line can vary.

FIG. 3D illustrate a laser operation system 300 and an imaging device 344 (e.g., vision system for laser trimming device), according to certain embodiments.

Errors between desired position and actual position of the laser on the trimming plate 310 (e.g., work plane) of the laser operation system 300 and improper focusing of the laser beam 301 on the trimming plate 310 directly affect the laser operation quality on dental appliances (e.g., leads to different cutting defects, smoothing defects, marking defects, bonding defects, etc.). Calibrating the laser scanning (e.g., positioning device 340) and focusing (e.g., focusing device 342) systems of the laser operation system 300 (e.g., aligner trimming machine) provides a higher product quality.

For calibration of the focusing device 342, controller 102 determines a position (e.g., optimal position) of the moving lens 302 that provides minimal irradiated laser spot to be used to melt plastic material of the dental appliance on the trimming plate 310. Conventionally, calibration of a focusing device is printing a calibration pattern (e.g., series of lines that can be seen by the unaided user's eye) on a sample and then a user manually performs a visual assessment of the calibration patterns, manually selects the best (e.g., perceived darkest) focused line, and is prompted to record the selection. This conventional focus calibration is not precise and is not fast and relies on perception of the user.

Calibration in the present disclosure may include integration with an imaging device 344 (e.g., vision system, high-resolution monochrome camera, ambient illumination) to acquire data (e.g., image data) during the calibration process. The intrinsic parameters of the camera and lens may be estimated via the camera calibration process using a chess-board sample. The intrinsic parameters may be used to perform accurate measurements through image processing.

In some embodiments, the laser spot size on the pattern may have a minimal shape (e.g., meets threshold dimensions) when the laser system is focused on the trimming plate 310 (e.g., via automatic focus calibration).

FIGS. 3E-G are associated with laser lines in a dental appliance provided by laser operations by a laser operation system, according to certain embodiments. The laser lines may illustrate laser spot shapes 350 and/or resulted trimming line 352 (e.g., cutline, etc.) for different laser line directions.

FIG. 3E illustrates a horizontal direction, FIG. 3F illustrates a diagonal direction, FIG. 3G illustrates a vertical direction.

Focus calibration may find a position (e.g., optimal position) of the moving lens 302 and/or objective lens 304 of FIGS. 3B-C along the optical axis 311 that causes the laser beam to be focused on a focal point that falls upon the trimming plate 310. The deviations from the optimal position (e.g., threshold position value) in both directions lead to laser spot size increase with the reduction of laser line contrast.

The focus offset may represent a delta relative to the optimal focus (e.g., threshold focus value). When the focus offset is zero, the objective lens 304 for the calibrated laser operation system 300 is at an optimal focus (e.g., meets a threshold focus value). The laser beam 301 then produces a narrowly focused irradiated spot at the focal point. By applying a positive or negative focus offset to the optimal focus, the moving lens is moved along the optical axis 311 and the working distance becomes correspondingly shorter or longer. The application of positive or negative focus offset may result in focusing and defocusing of the irradiated spot on the trimming plate 310. Negative values of focus offset may represent distances closer to the trimming plate 310 and positive values of focus offset may represent distances further away from the trimming plate 310.

FIGS. 3H-I illustrate layouts 360 of shapes (e.g., squares, rectangles, etc.) printed with different focus offsets for laser operation systems, according to certain embodiments. Determination of optimal focus offset (e.g., threshold focus offset) may be performed using a focus test as depicted in FIGS. 3H-l. FIGS. 3H-I illustrate patterns (e.g., square-shaped, rectangle-shaped) with increasing values of focus offset relative to current focus value.

Referring to FIG. 3H, layout 360A may illustrate a symmetric (e.g., substantially symmetric) layout of shapes (e.g., squares, rectangles, etc.) printed with different focus offsets for calibrated laser operation systems 300. Two different laser spot shapes are highlighted.

Referring to FIG. 3I, layout 360B may illustrate an asymmetric (e.g., substantially asymmetric, not substantially symmetric) layout of shapes (e.g., squares, rectangles, etc.) printed with different focus offsets for uncalibrated laser operation systems 300.

In each of FIGS. 3H-l, there are 18 shapes (e.g., squares, rectangles, etc.) engraved (e.g., 9 squares with positive offsets on the right part of symmetry line 362 and 9 squares with negative offsets on the left part pf symmetry line 362). Controller 102 may automatically estimate level of asymmetry between left and right parts by finding closest squares using intensity histogram matching. Level of asymmetry may be calculated by averaging all matched square offsets and then may be translated to focus offset. Shapes (e.g., square shapes) may be drawn by a laser using orthogonal directions. Some variability of laser spot shapes may be present during intensity histogram matching.

Layout 360A of FIG. 3H may be fully symmetrical so that the laser operation system 300 is calibrated. Layout 360B of FIG. 3I may be asymmetric (e.g., non-symmetrical) layout of shapes (e.g., squares, rectangles, etc.) sprinted with different focus offsets for an uncalibrated laser operation system 300. The controller 102 may find equal pairs (−1.0, +0.6), (−0.9, +0.5), (−0.8, +0.4) that is resulted to “+0.2” focus offset for the calibration.

FIG. 4A is an example data set generator 172 to create data sets for a machine learning model 190 (e.g., associated with laser operations of a dental appliance), according to certain embodiments. System 400A of FIG. 4A shows data set generator 172, data inputs 401, and target output 403.

In some embodiments, data set generator 172 generates a data set (e.g., training set, validating set, testing set) that includes one or more data inputs 401 (e.g., training input, validating input, testing input). In some embodiments, the data set further includes one or more target outputs 403 that correspond to the data inputs 401. The data set may also include mapping data that maps the data inputs 401 to the target outputs 403. Data inputs 401 may also be referred to as “features,” “attributes,” or “information.” In some embodiments, data set generator 172 may provide the data set to the training engine 182, validating engine 184, or testing engine 186, where the data set is used to train, validate, or test the machine learning model 190.

In some embodiments, data set generator 172 generates the data input 401 based on historical dental appliance data 154 and generates the target output 403 based historical laser operation data 158 associated with the historical dental appliance data 154. The data set generator 172 may determine the mapping from each set of the historical dental appliance data 154 to historical image data 164.

In some embodiments, data inputs 401 may include one or more sets of features for the historical dental appliance data 154. In some embodiments, data set generator 172 may generate a first data input corresponding to a first set of features to train, validate, or test a first machine learning model and the data set generator 172 may generate a second data input corresponding to a second set of features to train, validate, or test a second machine learning model.

In some embodiments, the data set generator 172 may discretize one or more of the data input 401 or the target output 403 (e.g., to use in classification algorithms for regression problems). Discretization of the data input 401 or target output 403 may transform continuous values of variables into discrete values. In some embodiments, the discrete values for the data input 401 indicate discrete portions of images to obtain a target output 403.

Data inputs 401 and target outputs 403 to train, validate, or test a machine learning model may include information for a particular facility (e.g., for a particular dental appliance production facility). For example, the historical dental appliance data 154 and historical laser operation data 158 may be for the same dental appliance production facility.

In some embodiments, subsequent to generating a data set and training, validating, or testing machine learning model 190 using the data set, the machine learning model 190 may be further trained, validated, or tested (e.g., further dental appliance data 152 and historical laser operation data 158) or adjusted (e.g., adjusting weights associated with input data of the machine learning model 190, such as connection weights in a neural network).

FIG. 4B is a block diagram illustrating determining predictive data 168 (e.g., associated with laser operations of a dental appliance), according to certain embodiments. FIG. 4B is a block diagram illustrating determining predictive data 168, according to certain embodiments. System 400B may be used to perform laser operations and/or calibration.

At block 430, the system 400B (e.g., predictive system 110 of FIG. 1) performs data partitioning (e.g., via data set generator 172 of server machine 170 of FIG. 1) of the historical data (e.g., historical dental appliance data 154 and historical laser operation data 158) to generate the training set 422, validation set 424, and testing set 426. For example, the training set may be 60% of the historical data, the validation set may be 20% of the historical data, and the testing set may be 20% of the historical data. The system 400B may generate a plurality of sets of features for each of the training set, the validation set, and the testing set. For example, if the historical data is associated with 10 laser tools 107 and 100 dental appliances (e.g., dental appliances that correspond to dental appliance data 152 to be processed by the 10 laser tools 107), a first set of features may be laser tools 1-5, a second set of features may be laser tools 6-10, the training set may be dental appliances 1-60, the validation set may be dental appliances 61-80, and the testing set may be dental appliances 81-100. In this example, the first set of features of the training set would be associated with dental appliance data 152 and laser operation data 157 associated with laser tools 1-5 and dental appliances 1-60.

At block 432, the system 400B performs model training (e.g., via training engine 182 of FIG. 1) using the training set 422. The system 400B may train multiple models using multiple sets of features of the training set 422 (e.g., a first set of features of the training set 422, a second set of features of the training set 422, etc.). For example, system 400B may train a machine learning model to generate a first trained machine learning model using the first set of features in the training set (e.g., dental appliance data associated with laser tools 1-5 and dental appliances 1-60) and to generate a second trained machine learning model using the second set of features in the training set (e.g., dental appliance data associated with laser tools 6-10 and dental appliances 1-60). In some embodiments, the first trained machine learning model and the second trained machine learning model may be combined to generate a third trained machine learning model (e.g., which may be a better predictor than the first or the second trained machine learning model on its own). In some embodiments, sets of features used in comparing models may overlap (e.g., first set of features associated with laser tools 1-7 and second set of features associated with laser tools 3-10). In some embodiments, hundreds of models may be generated including models with various permutations of features and combinations of models.

At block 434, the system 400B performs model validation (e.g., via validation engine 184 of FIG. 1) using the validation set 424. The system 400B may validate each of the trained models using a corresponding set of features of the validation set 424. For example, system 400B may validate the first trained machine learning model using the first set of features in the validation set (e.g., dental appliance data associated with laser tools 1-5 and dental appliances 61-80) and the second trained machine learning model using the second set of features in the validation set (e.g., dental appliance data associated with laser tools 6-10 and dental appliances 61-80). In some embodiments, the system 400B may validate hundreds of models (e.g., models with various permutations of features, combinations of models, etc.) generated at block 432. At block 434, the system 400B may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 432 where the system 400B performs model training using different sets of features of the training set. Responsive to determining that one or more of the trained models has an accuracy that meets a threshold accuracy, flow continues to block 436. The system 400B may discard the trained machine learning models that have an accuracy that is below the threshold accuracy (e.g., based on the validation set).

At block 436, the system 400B performs model selection (e.g., via selection engine 185 of FIG. 1) to determine which of the one or more trained models that meet the threshold accuracy has the highest accuracy (e.g., the selected model 428, based on the validating of block 434). Responsive to determining that two or more of the trained models that meet the threshold accuracy have the same accuracy, flow may return to block 432 where the system 400B performs model training using further refined training sets corresponding to further refined sets of features for determining a trained model that has the highest accuracy.

At block 438, the system 400B performs model testing (e.g., via testing engine 186 of FIG. 1) using the testing set 426 to test the selected model 428. The system 400B may test, using the first set of features in the testing set (e.g., dental appliance data associated with laser tools 1-5 and dental appliances 81-100), the first trained machine learning model to determine the first trained machine learning model meets a threshold accuracy (e.g., based on the first set of features of the testing set 426). Responsive to accuracy of the selected model 428 not meeting the threshold accuracy (e.g., the selected model 428 is overly fit to the training set 422 and/or validation set 424 and is not applicable to other data sets such as the testing set 426), flow continues to block 432 where the system 400B performs model training (e.g., retraining) using different training sets corresponding to different sets of features. Responsive to determining that the selected model 428 has an accuracy that meets a threshold accuracy based on the testing set 426, flow continues to block 440. In at least block 432, the model may learn patterns in the historical dental appliance data 154 to make predictions and in block 438, the system 400B may apply the model on the remaining data (e.g., testing set 426) to test the predictions.

At block 440, system 400B uses the trained model (e.g., selected model 428) to receive current dental appliance data 156 and determines (e.g., extracts), from the output of the trained model, predictive data 168 to produce molds and/or dental appliances or to perform corrective actions associated mold or dental appliance production.

In some embodiments, current laser operation data 159 corresponding to the current dental appliance data 156 is received and the model is re-trained based on the current dental appliance data 156 and current laser operation data 159.

In some embodiments, one or more operations of the blocks 430-440 may occur in various orders and/or with other operations not presented and described herein. In some embodiments, one or more operations of blocks 430-440 may not be performed. For example, in some embodiments, one or more of data partitioning of block 430, model validation of block 434, model selection of block 436, or model testing of block 438 may not be performed.

FIGS. 5A-E are flow diagrams of methods 500 D-E associated with dental appliance laser operations, according to certain embodiments.

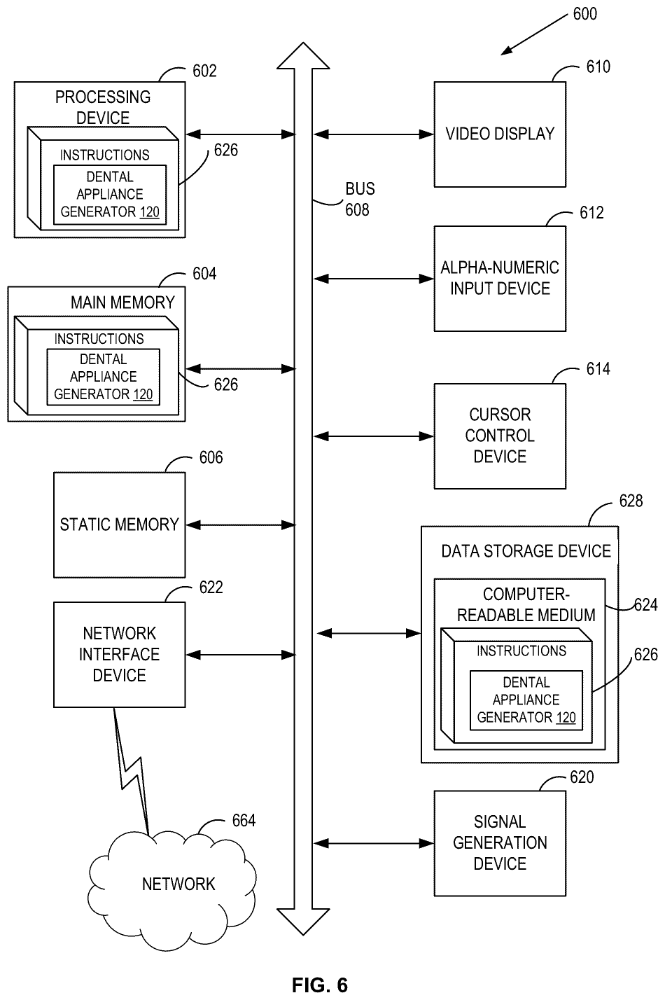

In some embodiments, one or more operations of methods 500A-E are performed by a processing logic of a computing device (e.g., controller 102 of FIG. 1, client device 104 of FIG. 1, predictive server 112 of FIG. 1, etc.) to automate one or more operations of producing an object (e.g., a dental appliance, marked dental appliance). The processing logic may include hardware (e.g., circuitry, dedicated logic, programmable logic, microcode, processing device, etc.), software (e.g., instructions executed by a processing device, a general purpose computer system, or a dedicated machine), firmware, microcode, or a combination thereof. For example, one or more operations of methods 500A-E may be performed by a processing device executing a program or module, such as dental appliance generator 120 of FIGS. 1 and 6.

It may be noted that components described with respect to one or more of FIGS. 1-4B may be used to illustrate aspects of FIGS. 5A-E. In some embodiments, a non-transitory machine-readable storage medium stores instructions that when executed by a processing device (e.g., of controller 102 of FIG. 1, client device 104 of FIG. 1, predictive server 112 of FIG. 1, predictive system 110 of FIG. 1, etc.) cause the processing device to perform methods 500A-E.

For simplicity of explanation, methods 500A-E are depicted and described as a series of acts. However, acts in accordance with this disclosure can occur in various orders and/or concurrently and with other acts not presented and described herein. Furthermore, not all illustrated acts may be performed to implement the methods 500A-E in accordance with the disclosed subject matter. In addition, those skilled in the art will understand and appreciate that the methods 500A-E could alternatively be represented as a series of interrelated states via a state diagram or events.

Referring to FIG. 5A, method 500A is associated with dental appliance production, according to certain embodiments.

At block 502, processing logic causes a sheet of plastic to be thermoformed over a mold to form a dental appliance associated with a dental arch of a user. Block 502 may include or may be similar to one or more of blocks 560-572 of method 500E of FIG. 5E.

At block 504, the processing logic causes one or more preliminary laser operations to form a laser line in the dental appliance disposed on the mold.

In some embodiments, the one or more preliminary laser operations include a cutting operation and the laser line includes a gingival cut line of the dental appliance. The one or more preliminary laser operations may include multiple passes of laser energy to cut through the dental appliance. Each pass of laser energy may cut a portion of the thickness of the dental appliance. For example, multiple passes of lower energy laser may be used to cut through a retainer. In some embodiments, the one or more preliminary laser operations include a marking operation (e.g., to form characters on the dental appliance) and the laser line includes an edge of a character marked in the dental appliance. In some embodiments, the one or more preliminary laser operations include a bonding operation to bond an object with a shell of the dental appliance and wherein the laser line includes a bonding line.

In some embodiments, the one or more preliminary laser operations include one or more pulsing operations along the laser line to form a ridged profile.

At block 506, the processing logic causes one or more post-processing laser operations to smooth at least a portion of the laser line in the dental appliance disposed on the mold.

In some embodiments, the one or more post-processing laser operations have a lower laser energy compared to the one or more preliminary laser operations. In some embodiments, the one or more post-processing laser operations employ a modified laser focal length to reduce the peak power absorbed at the at least a portion of the laser line (e.g., the one or more post-processing laser operations are out of focus to cause peak power to not be absorbed at the at least a portion of the laser line, out-of-focus to reduce peak power delivered into and/or absorbed by the target material). In some embodiments, the one or more post-processing laser operations have increased scanning speed with at least one of: a larger beam area to re-scan the at least a portion of the laser line with lower transmitted power density (e.g., larger beam area with reduced power density) compared to the one or more preliminary laser operations; or a shorter duty cycle (e.g., percentage on and off time of the laser) compared to the one or more preliminary laser operations. In some embodiments, a larger beam area with the same duty cycle as preliminary laser operations may be used to achieve a particular post-processing result. In some embodiments, the one or more post-processing laser operations have decreased scanning speed with lower laser output to increase pulse-to-pulse overlap and reduce peak-to-peak amplitudes of ridges along the at least a portion of the laser line compared to the one or more preliminary laser operations. In some embodiments, the one or more post-processing laser operations have offset pulses in phase to cause peak pulses to interact with the at least a portion of the laser line at an offset compared to the one or more preliminary laser operations to destructively interfere with a ridged profile along the at least a portion of the laser line.

In some embodiments, laser energy transmitted during the one or more post-processing laser operations are one or more of: directly reduced to a lower laser power or a shorter duty cycle compared to the one or more preliminary laser operations; or indirectly reduced via one or more of focus modification, targeting modification, or scanning rate modification compared to the one or more preliminary laser operations.

In some embodiments, the at least a portion of the laser line is one or more of a canine-premolar region of the laser line or high curvature regions of the laser line.

In some embodiments, a dental appliance laser operation system includes a first laser heat and a second laser head. The first laser head is configured to cause one or more preliminary laser operations to form a laser line in a dental appliance associated with a dental arch of a user. The second laser head configured to cause one or more post-processing laser operations to smooth at least a portion of the laser line in the dental appliance.

In some embodiments, the first laser head is configured to cause the one or more preliminary laser operations at one or more first angles. The second laser head may be configured to cause the one or more post-processing laser operations at one or more second angles that are different than the one or more first angles.

In some embodiments, the first laser head has first dedicated energy output properties and the second laser head has second dedicated energy output properties that are different from the first dedicated energy output properties. The second laser head may be configured to cause the one or more post-processing laser operations at one or more of a modified power output, modified focus, or modified wavelength compared to the one or more preliminary laser operations. In some embodiments, the first laser head and/or the second laser head may be continuous wave (CW) lasers that are not pulsed. In some embodiments, the first laser head (e.g., cutting laser head) is pulsed for cutting and the second laser head is a CW laser. The second laser head may be configured to cause the one or more post-processing laser operations at a continuous wave (e.g., the first laser head may be configured to cause the one or more preliminary laser operations at a non-continuous wave (e.g., a pulsed laser operation).

In some embodiments, the first laser head and the second laser head are configured to apply laser energy to the at least a portion of the laser line at opposing angles to alter cutline ridges to be a cross-hatched or three-dimensional ridged topography.

FIG. 5A may use a trained machine learning model of one or more of FIGS. 5B-C to perform one or more operations.

Referring to FIG. 5B, method 500B is associated with dental appliance production, according to certain embodiments.

At block 520, processing logic identifies historical dental appliance data. The historical dental appliance data may be associated with historical dental appliances that were thermoformed via a thermoforming system. In some embodiments, the historical dental appliance data include at least one of historical images or historical three-dimensional topography data of historical dental appliances.

In some embodiments, at block 522, processing logic identifies historical laser operation data associated with historical laser operations performed by historical laser tools on the historical dental appliances. In some embodiments, the historical laser operation data is associated with one or more of historical preliminary laser operations or historical post-processing laser operations.

At block 524, processing logic trains a machine learning model using training input including the historical dental appliance data and target output including historical laser operation data to generate a trained machine learning model (e.g., supervised machine learning model). The trained machine learning model may be configured to provide output associated with predicted image data for performance of laser operations via laser tools of dental appliances.

Referring to FIG. 5C, method 500C is associated with dental appliance production, according to certain embodiments.

At block 530, processing logic identifies dental appliance data of a dental appliance (e.g., dental appliance of block 502 of FIG. 5A).

At block 532, processing logic provides the dental appliance data as input to a trained machine learning model (e.g., trained via method 500B). In some embodiments, the trained machine learning model is trained using input of historical dental appliance data and target output including historical laser operation data.

At block 534, processing logic obtains, from the trained machine learning model, output associated with predictive data.

At block 536, processing logic determines, based on the predictive data, laser operation data of one or more of the one or more preliminary laser operations or the one or more post-processing laser operations.

At block 538, processing logic causes, based on the laser operation data, one or more laser operations (e.g., dental appliance production, block 504 and/or block 506 of FIG. 5A).

Referring to FIG. 5D, method 500D is associated with dental appliance production, according to certain embodiments.

At block 540, processing logic causes, via a dental appliance laser system, laser operations to provide a laser line on a material. In some embodiments, the material is a paper and the one or more laser operations to form the laser line cause a shape to be cut into the paper. In some embodiments, the one or more laser operations include one or more of dental appliance trimming operations or dental appliance marking operations.

At block 542, the processing logic identifies images of the laser line on the material. In some embodiments, the images are captured via an imaging device. The image data may further include a distance between the imaging device and the material and a resolution of the imaging device.

At block 544, the processing logic calibrates, based on the images, the dental appliance laser system.

In some embodiments, the laser operations to provide the laser line cause formation of a shape including one or more geometric properties. In some embodiments, the calibrating includes: determining the one or more geometric properties of the shape formed on the material; determining offset data associated with differences between at least one of the one or more geometric properties and one or more threshold geometric values; and causing the dental appliance laser system to be adjusted based on the offset data.

In some embodiments, the calibrating of the dental appliance laser system includes adjusting one or more of: a plate actuator configured to move a trimming plate of the dental appliance laser system; a mirror actuator configured to move a mirror of the dental appliance laser system; or a lens actuator configured to move a lens of the dental appliance laser system.

Referring to FIG. 5E, method 500E is associated with dental appliance production, according to certain embodiments.

At block 560, processing logic identifies digital model of a mold (e.g., dental mold). In some embodiments, the mold associated with a dental arch of a user, such as a mold usable to form a dental appliance. In some embodiments, the mold is to be used to form a dental appliance (e.g., to be used in relation to a dental arch of a user), such as incremental palatal expanders, aligners (e.g., aligners with or without mandibular advancement structures and/or other structures), dental attachment templates, and/or other dental appliances.

A shape of a dental arch for a patient at a treatment stage may be determined based on a treatment plan to generate the digital model of the mold. In the example of orthodontics, the treatment plan may be generated based on an intraoral scan of a dental arch (e.g., dental arch to receive a dental appliance, dental arch to be modeled). The intraoral scan of a patient's dental arch may be performed to generate a 3D virtual model of the patient's dental arch. For example, a full scan of the mandibular and/or maxillary arches of a patient may be performed to generate 3D virtual models thereof. The intraoral scan may be performed by creating multiple overlapping intraoral images from different scanning stations and then stitching together the intraoral images to provide a composite 3D virtual model. In other applications, virtual 3D models may also be generated based on scans of an object to be modeled or based on use of computer aided drafting techniques (e.g., to design the virtual 3D mold). Alternatively, an initial negative mold may be generated from an actual object to be modeled. The negative mold may then be scanned to determine a shape of a positive mold that will be produced.

Once the virtual 3D model of the patient's dental arch is generated, a dental practitioner may determine a desired treatment outcome, which includes final positions and orientations for the patient's teeth. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model of the patient's dental arch at that treatment stage may be generated. The shape of each virtual 3D model will be different. The original virtual 3D model, the final virtual 3D model and each intermediate virtual 3D model is unique and customized to the patient.

The processing logic may determine an initial shape for a mold of the patient's dental arch at a treatment stage based on the digital model of the dental arch at that treatment stage. Processing logic may additionally determine one or more features to add to the object.

The processing logic may determine a final shape for the mold and may generate a digital model of the mold. Alternatively, the digital model may have already been generated. In such an instance, processing logic may update the already generated digital model to include one or more determined features for the mold. The digital model may be represented in a file such as a computer aided drafting (CAD) file or a 3D printable file such as a stereolithography (STL) file. The digital model may include instructions that will control a fabrication system or device in order to produce the mold with specified geometries.

At block 562, processing logic causes, based on the digital model, the mold (e.g., dental mold) to be simultaneously printed (e.g., via 3D printing, via rapid prototyping machine, on a tray or plate).

A mold may be generated based on the digital model of block 560. A virtual 3D model of a patient's dental arch may be used to generate a unique customized mold associated with the dental arch at a particular stage of treatment. The shape of the mold may be at least in part based on the shape of the virtual 3D model for that treatment stage. The mold may correspond to a dental arch of a patient and the mold may include a sloping portion that commences below a gum line of the dental arch and extends away from the dental arch to a lower portion of the mold. In some embodiments, the mold is generated with the sloping portion commencing below the gum line (e.g., to assist in the release of the thermoformed sheet of plastic from the mold). The mold may be formed using a rapid prototyping equipment (e.g., 3D printers) to manufacture the mold using additive manufacturing techniques (e.g., stereolithography) or subtractive manufacturing techniques (e.g., milling). The digital model may be input into a rapid prototyping machine. The rapid prototyping machine then manufactures the mold using the digital model. One example of a rapid prototyping manufacturing machine is a 3D printer. 3D Printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

In one embodiment, stereolithography (SLA), also known as optical fabrication solid imaging, is used to fabricate an SLA mold. In SLA, the mold is fabricated by successively printing thin layers of a photo-curable material (e.g., a polymeric resin) on top of one another. A platform rests in a bath of a liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured. In one embodiment, a system such as described earlier herein (e.g., system 100, dental appliance production equipment 106) is used to print the mold.

Materials such as a polyester, a co-polyester, a polycarbonate, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or combinations thereof, may be used to directly form the mold. The materials used for fabrication of the mold can be provided in an uncured form (e.g., as a liquid, resin, powder, etc.) and can be cured (e.g., by photopolymerization, light curing, gas curing, laser curing, crosslinking, etc.). The properties of the material before curing may differ from the properties of the material after curing.

Optionally, the rapid prototyping techniques described herein allow for fabrication of a mold including multiple materials, referred to herein as “multi-material direct fabrication.” In some embodiments, a multi-material direct fabrication method involves concurrently forming a mold from multiple materials in a single manufacturing step. For instance, a multi-tip extrusion apparatus can be used to selectively dispense multiple types of materials (e.g., resins, liquid, solids, or combinations thereof) from distinct material supply sources in order to fabricate a mold from a plurality of different materials. Alternatively or in combination, a multi-material direct fabrication method can involve forming a mold from multiple materials in a plurality of sequential manufacturing steps. For instance, a first portion of the mold (e.g., a main portion of the mold) can be formed from a first material in accordance with any of the direct fabrication methods herein, then a second portion of the mold (e.g., complex features added to the mold) can be formed from a second material in accordance with methods herein, and so on, until the entirety of the mold has been formed. The relative arrangement of the first and second portions can be varied as desired. In one embodiment, multi-material direct fabrication is used to cause a first material to be used for the markings of the cut line on the mold, and to cause one or more additional materials to be used for the remainder of the mold.

In some embodiments, a dental appliance is to be formed on the mold (e.g., by thermoforming the dental appliance over the mold). The dental appliance may be configured to provide forces to move the patient's teeth or may be configured to perform other actions such as to protect a patient's teeth from bruxism. The shape of each dental appliance is unique and customized for a particular patient and a particular treatment stage. In an example, dental appliances can be pressure formed or thermoformed over printed molds. Each mold may be used to fabricate a dental appliance that will apply forces to the patient's teeth at a particular stage of the orthodontic treatment. The dental appliances each have teeth-receiving cavities that receive and resiliently reposition the teeth in accordance with a particular treatment stage.

Responsive to forming the mold, the mold may remain on the tray or plate. The processing logic may identify the molds via an imaging system (e.g., part of an imaging station, part of thermoforming station, part of trimming station, part of robot used to move the mold, etc.). The processing logic may cause the mold to be moved to a thermoforming station via a robot arm, conveyor belt, or other transport mechanism.

At block 564, processing logic identifies a sheet of plastic based on the mold. The sheet of plastic may be sized (e.g., cut) based on the size of the mold. The sheet of plastic may be an elastic thermoplastic, a sheet of polymeric material, etc.

At block 566, processing logic causes the sheet of plastic to be secured to the pallet. The sheet of plastic may be lowered onto the pallet so that holding pins of the pallet pierce the sheet of plastic to secure the sheet of plastic to the pallet.

At block 568, processing logic causes, via the heating device and the heating mask, the sheet of plastic to be heated. The sheet of plastic may be secured to a pallet and the sheet of plastic secured to the pallet may be surrounded with a mask prior to heating the sheet of plastic. A pressurized cylinder may lower the mask onto the sheet of plastic secured to the pallet. The sheet of plastic may be heated to a temperature at which the sheet of plastic becomes pliable. The sheet of plastic may be heated using a ceramic heater, convection oven, or infrared heater. The mask may allow the sheet of plastic to be heated to about 336° F. without hanging to avoid air leaks.

At block 570, processing logic causes, via the lifting device, the mold (e.g., disposed on the tray or plate) to be lifted.

At block 572, processing logic causes, via the thermoforming chamber, the heat sheet of plastic to be thermoformed on the mold. To thermoform the heated sheet of plastic over the mold, pressure may concurrently be applied to the sheet of plastic to form the now pliable sheet of plastic around the mold (e.g., with features that will imprint markings and/or elements in the dental appliance formed on the mold). Once the sheet cools, it will have a shape that conforms to the mold. In one embodiment, a release agent (e.g., a non-stick material) is applied to the mold before forming the dental appliances (e.g., shells). This may facilitate later removal of the molds from the shells.

At block 574, processing logic causes, via laser tools, performance of laser operations (e.g., laser marking and/or laser trimming) on the dental appliances (e.g., thermoformed sheet of plastic). The laser operations may be performed based on parameters (e.g., power data, frequency data, pitch data, resolution data, focal data, velocity data, etc.). The laser operations may include preliminary laser operations (e.g., cutting operations, marking operations, bonding operations, etc.) and post-processing laser operations (e.g., smoothing operations). The laser tools may be calibrated prior to, during, and/or after the performance of one or more of the laser operations.

The thermoformed sheet of plastic may be removed from the mold (e.g., using a shell removal device) after being trimmed. The thermoformed sheet of plastic may be trimmed to generate the dental appliance. In some embodiments, the portion of thermoformed sheet of plastic that is disposed on a portion of the mold that slopes outward below the gum line is removed during the trimming of the thermoformed sheet of plastic to generate the dental appliance. Before or after the thermoformed sheet of plastic is removed from the mold for a treatment stage, the thermoformed sheet of plastic is trimmed along one or more cut lines (also referred to as a trim line). The cut line may be a gingival cut line that represents an interface between a dental appliance and a patient's gingiva. In some embodiments, the dental appliance is cut by a computer controlled trimming machine such as a CNC machine or a laser trimming machine. The computer controlled trimming machine may control an angle and position of a cutting tool of the trimming machine to trim the thermoformed sheet of plastic.

In some embodiments, processing logic causes image data associated with performance of laser operations on the dental appliance to be captured. The processing logic may update performance of the laser operations (e.g., update the parameters) based on the image data.

At block 576, processing logic causes, via a transfer device, the dental appliances to be transferred.

In some embodiments, the transferring of the dental appliances (e.g., on a mold secured to a tray or plate) is via a conveyor system (e.g., via lateral movement). In some embodiments, the transferring of the dental appliances is via a dial system (e.g., via rotational movement). In some embodiments, the transferring of the dental appliances is via robots.

In some embodiments, the mold is transferred to be located below the thermoforming station and is lifted to have the heated sheet thermoformed over the first mold and the second mold. In some embodiments, the transferring of the first mold to be located below the thermoforming station is via lateral movement (e.g., conveyor system). In some embodiments, the transferring of the mold to be located below the thermoforming station is via rotational movement (e.g., dial system).

In some embodiments, the techniques herein can be used to form molds, such as thermoforming molds. Examples of these can be found in: U.S. Pat. No. 9,943,991, by inventors Tanugula et al., entitled “Mold with separable features;” U.S. Pat. No. 9,943,386, to inventors Webber et al., entitled “Mold with weakened areas;” and U.S. Pat. No. 8,776,391 to inventors Kaza et al., entitled “System for post-processing orthodontic appliance molds;” as well as any continuation or divisional application claiming priority and any utility or provisional application to which these claim priority therefrom. These patents/applications are hereby incorporated by reference as if set forth fully herein.

In some embodiments, the techniques herein can be used to form appliances with mandibular repositioning features. Examples of these can be found in: U.S. Pat. No. 9,844,424 by inventors Wu et al., entitled, “Dental appliance with repositioning jaw elements;” U.S. Pat. Pub. No. 2015/0238280 by inventors Wu et al., entitled “Dental appliance with repositioning jaw elements;” U.S. Pat. No. 10,213,277 by inventors Webber et al., entitled “Dental appliance binding structure;” as well as any continuation or divisional application claiming priority and any utility or provisional application to which these claim priority therefrom. These patents/applications are hereby incorporated by reference as if set forth fully herein.

In some embodiments, the techniques herein can be used to form palatal expanders. Examples can be found in: U.S. Pat. No. 9,610,141 by inventors Kopelman et al., entitled, “Arch expanding appliance;” U.S. Pat. No. 7,192,273 by inventor McSurdy entitled “System and method for palatal expansion;” U.S. Pat. No. 7,874,836 by inventor McSurdy entitled “System and method for palatal expansion;” as well as any continuation or divisional application claiming priority and any utility or provisional application to which these claim priority therefrom. These patents/applications are hereby incorporated by reference as if set forth fully herein.

In some embodiments, the techniques herein can be used to form attachment formation templates. Examples can be found in: U.S. Pat. Pub. No. 2017/0007368 by inventor Boronkay entitled “Direct fabrication of attachment templates with adhesive;” U.S. Pat. Pub. No. 2017/0165032 by inventors Webber et al., entitled “Dental attachment placement structure;” U.S. Pat. Pub. No. 2017/0319296 by inventors Webber et al., entitled “Dental attachment placement structure;” the contents of U.S. patent application Ser. No. 16/366,686 by inventors Webber et al., entitled “Dental attachment placement structure;” as well as any continuation or divisional application claiming priority and any utility or provisional application to which these claim priority therefrom. These patents/applications are hereby incorporated by reference as if set forth fully herein.

In some embodiments, the techniques herein can be used to form directly fabricated aligners. Examples can be found in: U.S. Pat. App. Pub. No. 2016/0310236 by inventors Kopelman et al., entitled “Direct fabrication of orthodontic appliances with elastics;” U.S. Pat. App. Pub. No. 2017/0007365 to Kopelman et al., entitled “Direct fabrication of aligners with interproximal force coupling;” U.S. Pat. App. Pub. No. 2017/0007359 to Kopelman et al., entitled “Direct fabrication of orthodontic appliances with variable properties;” U.S. Pat. App. Pub. No. 2017/0007360 to Kopelman et al., entitled “Systems, apparatuses and methods for dental appliances with integrally formed features;” U.S. Pat. No. 10,363,116 to Boronkay entitled “Direct fabrication of power arms;” U.S. Pat. App. Pub. No. 2017/0007366 to Kopeleman et al., entitled “Direct fabrication of aligners for arch expansion;” U.S. Pat. App. Pub. No. 2017/0007367 to Li et al., entitled “Direct fabrication of palate expansion and other application;” as well as any continuation or divisional application claiming priority and any utility or provisional application to which these claim priority therefrom. These patents/applications are hereby incorporated by reference as if set forth fully herein.

Examples of materials that can be used with the embodiments discussed herein include the subject matter of U.S. Pat. Pub. No. 2017/0007362, by inventors Yan CHEN et al., entitled, “Dental Materials Using Thermoset Polymers;” International Patent Application Number PCT/US2019/030683 to ALIGN TECHNOLOGY, INC., entitled “Curable Composition for Use in a High Temperature Lithography-Based Photopolymerization Process and Method of Producing Crosslinked Polymers Therefrom; and International Patent Application Number PCT/US2019/030687 to ALIGN TECHNOLOGY, INC., entitled, “Polymerizable Monomers and Method of Polymerizing the Same.” These patents/applications are hereby incorporated by reference as if set forth fully herein. As noted herein, the hybrid 3D printing techniques may combine advantages of SLA, DLP and FDM into a single technology that can be used as the basis of 3D printing objects (dental appliances, hearing aids, medical implants, etc.) for mass production.

FIG. 6 illustrates a diagrammatic representation of a machine in the example form of a computing device 600 within which a set of instructions, for causing the machine to perform any one or more of the methodologies discussed with reference to the methods of FIGS. 5A-E. In alternative embodiments, the machine may be connected (e.g., networked) to other machines in a Local Area Network (LAN), an intranet, an extranet, or the Internet. For example, the machine may be networked to a rapid prototyping apparatus such as a 3D printer or SLA apparatus. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

In some embodiments, computing device 600 is one or more of controller 102, client device 104, dental appliance production equipment 106, imaging device 108, predictive server 112, server machine 170, or server machine 180. In some embodiments, computing device 600 includes one or more of the components illustrated in FIG. 6.

The example computing device 600 includes a processing device 602, a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 628), which communicate with each other via a bus 608.

Processing device 602 represents one or more general-purpose processors such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic (instructions 626) for performing operations and acts discussed herein.

The computing device 600 may further include a network interface device 622 for communicating with a network 664. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 628 may include a machine-readable storage medium (or more specifically a non-transitory machine-readable storage medium) 624 on which is stored one or more sets of instructions 626 embodying any one or more of the methodologies or functions described herein. A non-transitory machine-readable storage medium refers to a storage medium other than a carrier wave. The instructions 626 may also reside, completely or at least partially, within the main memory 604 and/or within the processing device 602 during execution thereof by the computing device 600, the main memory 604 and the processing device 602 also constituting machine-readable storage media.

The machine-readable storage medium 624 may also be used to store one or more instructions for dental appliance production and/or a dental appliance generator 120, which may perform one or more of the operations of methods 500A-E described with reference to FIGS. 5A-E. The machine-readable storage medium 624 may also store a software library containing methods that call a dental appliance generator 120. While the machine-readable storage medium 624 is shown in an example embodiment to be a single medium, the term “non-transitory machine-readable storage medium” should be taken to include a single medium or multiple media (e.g., a centralized or distributed database, and/or associated caches and servers) that store the one or more sets of instructions. The term “non-transitory machine-readable storage medium” shall also be taken to include any medium that is capable of storing or encoding a set of instructions for execution by the machine and that cause the machine to perform any one or more of the methodologies of the present disclosure. The term “non-transitory machine-readable storage medium” shall accordingly be taken to include, but not be limited to, solid-state memories, and optical and magnetic media.

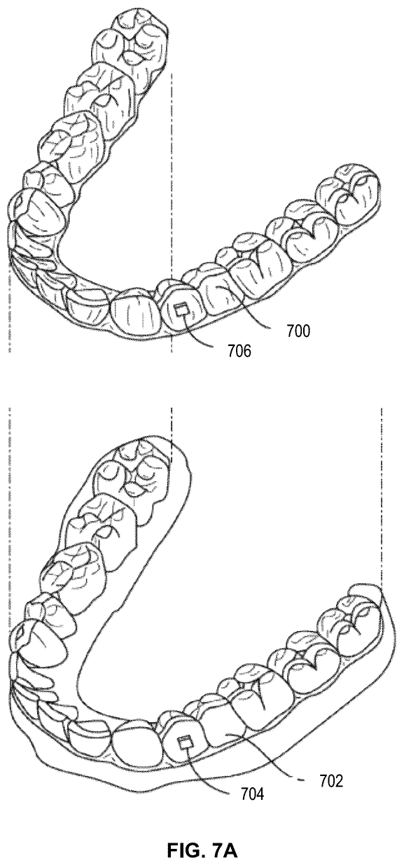

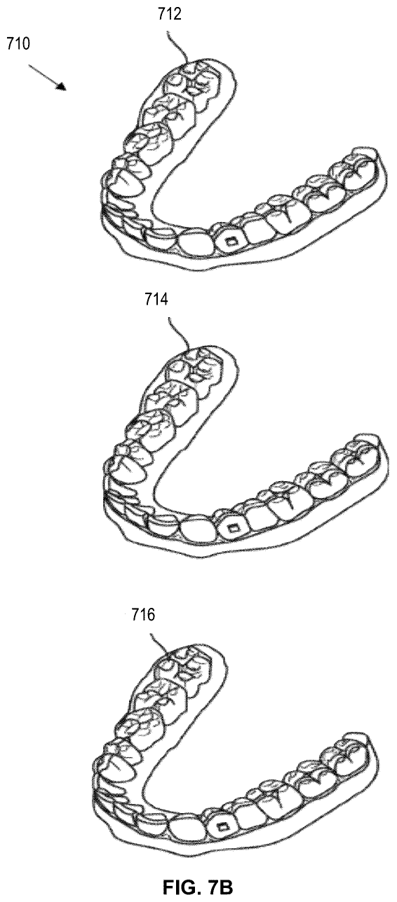

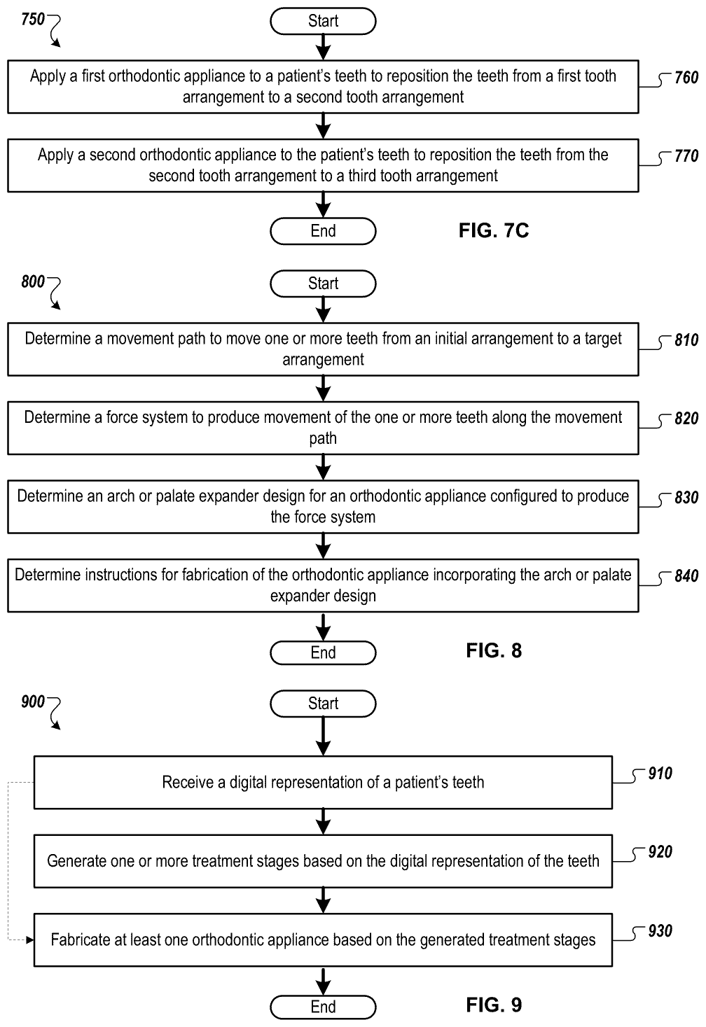

FIG. 7A illustrates an exemplary tooth repositioning dental appliance or aligner 700 that can be worn by a patient in order to achieve an incremental repositioning of individual teeth 702 in the jaw. The aligner 700 may be formed using preliminary laser operations, post-processing laser operations, and/or calibration, as disclosed herein. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. A “polymeric material,” as used herein, may include any material formed from a polymer. A “polymer,” as used herein, may refer to a molecule composed of repeating structural units connected by covalent chemical bonds often characterized by a substantial number of repeating units (e.g., equal to or greater than 3 repeating units, optionally, in some embodiments equal to or greater than 10 repeating units, in some embodiments greater or equal to 30 repeating units) and a high molecular weight (e.g. greater than or equal to 10,000 Da, in some embodiments greater than or equal to 50,000 Da or greater than or equal to 100,000 Da). Polymers are commonly the polymerization product of one or more monomer precursors. The term polymer includes homopolymers, or polymers consisting essentially of a single repeating monomer subunit. The term polymer also includes copolymers which are formed when two or more different types of monomers are linked in the same polymer. Useful polymers include organic polymers or inorganic polymers that may be in amorphous, semi-amorphous, crystalline or semi-crystalline states. Polymers may include polyolefins, polyesters, polyacrylates, polymethacrylates, polystyrenes, Polypropylenes, polyethylenes, Polyethylene terephthalates, poly lactic acid, polyurethanes, epoxide polymers, polyethers, poly(vinyl chlorides), polysiloxanes, polycarbonates, polyamides, poly acrylonitriles, polybutadienes, poly(cycloolefins), and copolymers. The systems and/or methods provided herein are compatible with a range of plastics and/or polymers. Accordingly, this list is not all inclusive, but rather is exemplary. The plastics can be thermosets or thermoplastics. The plastic may be a thermoplastic.

Examples of materials applicable to the embodiments disclosed herein include, but are not limited to, those materials described in the following patent applications filed by Align Technology: “MULTILAYER DENTAL APPLIANCES AND RELATED METHODS AND SYSTEMS,” U.S. Pat. No. 9,655,691 to Li, et al., filed May 14, 2012; “SYSTEMS AND METHODS FOR VARYING ELASTIC MODULUS APPLIANCES,” U.S. Pat. No. 6,964,564 to Phan, et al., filed Jul. 26, 2002; “METHODS OF MAKING ORTHODONTIC APPLIANCES,” U.S. Pat. No. 7,641,828 to DeSimone, et al., filed Oct. 12, 2004; “TREATMENT OF TEETH BY ALIGNERS,” U.S. Pat. No. 8,740,614 to Wen et al., filed Jul. 29, 2009; and any applications claiming benefit therefrom or providing benefit thereto (including publications and issued patents), including any divisional, continuation, or continuation-in-part thereof, the content of which are incorporated by reference herein.

Examples of materials applicable to the embodiments disclosed herein include a hard polymer layer disposed between two soft polymer layers. In some embodiments, the hard inner polymer layer includes a co-polyester and has a polymer layer elastic modulus. In some embodiments, a first soft outer polymer layer and a second soft outer polymer layer each include a thermoplastic polyurethane elastomer and each have a soft polymer elastic modulus less than the hard polymer layer elastic modulus, a flexural modulus of greater than about 35,000 psi, a hardness of about 60 A to about 85 D, and a thickness in a range from 25 microns to 100 microns. In some embodiments, the hard inner polymer layer is disposed between the first soft outer polymer layer and the second soft outer polymer layer so as to reduce degradation of the resilient position force applied to the teeth when the appliance is worn. The hard polymer layer can include a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate or a combination thereof (e.g., a blend of at least two of the listed hard polymeric materials). In some embodiments, the hard polymer layer includes two or more hard polymer layers. The soft outer polymer material may include a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or a combination thereof (e.g., a blend of at least two of the listed soft polymeric materials). The soft polymer layers can be the same material or a different material.

Examples of materials applicable to the embodiments disclosed herein include a middle layer disposed between two layers. The two layers individually include a thermoplastic polymer having a flexural modulus of from about 1,000 MPa to 2,500 MPa and a glass transition temperature and/or melting point of from about 80° C. to 180° C. The middle layer includes a polyurethane elastomer having a flexural modulus of from about 50 MPa to about 500 MPa and one or more of a glass transition temperature and/or melting point of from about 90° C. to about 220° C. The polymeric sheet composition has a combined thickness of the middle layer and the outer layers of from 250 microns to 2000 microns and a flexural modulus of from 500 MPa to 1,500 MPa. In some embodiments, the outer layers include one or more of a co-polyester, a polycarbonate, a polyester polycarbonate blend, a polyurethane, a polyamide, or a polyolefin. The middle layer may have a Shore hardness of from A90 to D55 and a compression set of less than 35% after 22 hours at 25° C. In some embodiments, the outer layers have a lateral restoring force of less than 100 Newtons (N) per square centimeter when displayed by 0.05 mm to 0.1 mm relative to each other. In some embodiments, the interplay peel strength between the outer layers and the middle layer is greater than 50 N per 2.5 cm. In some embodiments, the combined thickness of the outer layers is from 50 microns to 1,000 microns. In some embodiments one or more of the outer layers include a microcrystalline polyamide including from 50 to 100 mole % of C6 to C14 aliphatic diacid moieties and about 50 to 100 mole % of 4,4′-methylene-bis(cyclohexylamine), having a glass transition of between about 100° C. and 180° C., a heat of fusion of less than 20 J/g and a light transmission of greater than 80%. In some embodiments, one or more of the outer layers includes a co-polyester including: a dicarboxylic acid component including 70 mole % to 100 mole % of terephthalic acid residues; and a diol component including (i) 0 to 90 mole % ethylene glycol, (ii) 5 mole % to 50 mole % of 2,2,4,4-tetramethyl-1,3-cyclobutanediol residues, (iii) 50 mole % to 95 mole % 1,4-cyclohexanedimethanol residues, and (iv) 0 to 1 mole % of a polyol having three or more hydroxyl groups, where the sum of the mole % of diol residues (i), (ii), (iii), and (iv) amounts to 100 mole % and the co-polyester exhibits a glass transition temperature Tg from 80° C. to 150° C. In some embodiments, the middle layer includes an aromatic polyether polyurethane having a Shore hardness of from A90 to D55 and a compression set of less than 35%, where the interlayer peel strength between the outer layers and the middle layer is greater than 50 N per 2.5 cm. In some embodiments, one or more of the outer layers includes a polyurethane that includes: a di-isocyanate including 80 mole % to 100 mole % of methylene diphenyl diisocyanate residues and/or hydrogenated methylene diphenyl diisocyanate; and a diol component including: (i) 0 to 100 mole % hexamethylene diol; and (ii) 0 to 50 mole % 1,4-cyclohexanedimethanol, where the sum of (i) and (ii) amounts to greater than 90 mole % and the polyurethane has a glass transition temperature Tg from about 85° C. to about 150° C.

Although polymeric aligners are discussed herein, the techniques disclosed may also be applied to aligners having different materials. Some embodiments are discussed herein with reference to orthodontic aligners (also referred to simply as aligners). However, embodiments also extend to other types of shells formed over molds, such as orthodontic retainers, orthodontic splints, sleep appliances for mouth insertion (e.g., for minimizing snoring, sleep apnea, etc.) and/or shells for non-dental applications. Accordingly, it should be understood that embodiments herein that refer to aligners also apply to other types of shells. For example, the principles, features and methods discussed may be applied to any application or process in which it is useful to perform simultaneous forming multiple shells which are any suitable type of shells that are form fitting devices such as eye glass frames, contact or glass lenses, hearing aids or plugs, artificial knee caps, prosthetic limbs and devices, orthopedic inserts, as well as protective equipment such as knee guards, athletic cups, or elbow, chin, and shin guards and other like athletic/protective devices.

The aligner 700 can fit over all teeth present in an upper or lower jaw, or less than all of the teeth. The appliance can be designed specifically to accommodate the teeth of the patient (e.g., the topography of the tooth-receiving cavities matches the topography of the patient's teeth) and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements 704 on teeth 702 with corresponding receptacles or apertures 706 in the aligner 700 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 7B illustrates a tooth repositioning system 710 including a plurality of appliances 712, 714, 716. The appliances 712, 714, 716 may be formed using preliminary laser operations, post-processing laser operations, and/or calibration, as disclosed herein. Alternatively, the appliances 712, 714, 716 may be directly manufactured using a rapid prototyping machine such as that discussed herein above. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 710 can include a first appliance 712 corresponding to an initial tooth arrangement, one or more intermediate appliances 714 corresponding to one or more intermediate arrangements, and a final appliance 716 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

In some embodiments, the appliances 712, 714, 716 (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In an example of indirect fabrication, a mold of a patient's dental arch may be fabricated from a digital model of the dental arch, and a shell may be formed over the mold (e.g., by thermoforming a polymeric sheet over the mold of the dental arch and then trimming the thermoformed polymeric sheet). The fabrication of the mold may be performed by a rapid prototyping machine (e.g., a stereolithography (SLA) 3D printer). The rapid prototyping machine may receive digital models of molds of dental arches and/or digital models of the appliances 712, 714, 716 after the digital models of the appliances 712, 714, 716 have been processed by processing logic of a computing device, such as the computing device in FIG. 6. The processing logic may include hardware (e.g., circuitry, dedicated logic, programmable logic, microcode, etc.), software (e.g., instructions executed by a processing device), firmware, or a combination thereof. For example, one or more operations may be performed by a processing device executing a dental appliance generator 120.

To manufacture the molds, a shape of a dental arch for a patient at a treatment stage is determined based on a treatment plan. In the example of orthodontics, the treatment plan may be generated based on an intraoral scan of a dental arch to be modeled. The intraoral scan of the patient's dental arch may be performed to generate a 3D virtual model of the patient's dental arch (mold). For example, a full scan of the mandibular and/or maxillary arches of a patient may be performed to generate 3D virtual models thereof. The intraoral scan may be performed by creating multiple overlapping intraoral images from different scanning stations and then stitching together the intraoral images to provide a composite 3D virtual model. In other applications, virtual 3D models may also be generated based on scans of an object to be modeled or based on use of computer aided drafting techniques (e.g., to design the virtual 3D mold). Alternatively, an initial negative mold may be generated from an actual object to be modeled (e.g., a dental impression or the like). The negative mold may then be scanned to determine a shape of a positive mold that will be produced.

Once the virtual 3D model of the patient's dental arch is generated, a dental practitioner may determine a desired treatment outcome, which includes final positions and orientations for the patient's teeth. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model of the patient's dental arch at that treatment stage may be generated. The shape of each virtual 3D model will be different. The original virtual 3D model, the final virtual 3D model and each intermediate virtual 3D model is unique and customized to the patient.

Accordingly, multiple different virtual 3D models (digital designs) of a dental arch may be generated for a single patient. A first virtual 3D model may be a unique model of a patient's dental arch and/or teeth as they presently exist, and a final virtual 3D model may be a model of the patient's dental arch and/or teeth after correction of one or more teeth and/or a jaw. Multiple intermediate virtual 3D models may be modeled, each of which may be incrementally different from previous virtual 3D models.

Each virtual 3D model of a patient's dental arch may be used to generate a unique customized physical mold of the dental arch at a particular stage of treatment. The shape of the mold may be at least in part based on the shape of the virtual 3D model for that treatment stage. The virtual 3D model may be represented in a file such as a computer aided drafting (CAD) file or a 3D printable file such as a stereolithography (STL) file. The virtual 3D model for the mold may be sent to a third party (e.g., clinician office, laboratory, manufacturing facility or other entity). The virtual 3D model may include instructions that will control a fabrication system or device in order to produce the mold with specified geometries.

A clinician office, laboratory, manufacturing facility or other entity may receive the virtual 3D model of the mold, the digital model having been created as set forth above. The entity may input the digital model into a rapid prototyping machine. The rapid prototyping machine then manufactures the mold using the digital model. One example of a rapid prototyping manufacturing machine is a 3D printer. 3D printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

Appliances may be formed from each mold and when applied to the teeth of the patient, may provide forces to move the patient's teeth as dictated by the treatment plan. The shape of each appliance is unique and customized for a particular patient and a particular treatment stage. In an example, the appliances 712, 714, 716 can be pressure formed or thermoformed over the molds. Each mold may be used to fabricate an appliance that will apply forces to the patient's teeth at a particular stage of the orthodontic treatment. The appliances 712, 714, 716 each have teeth-receiving cavities that receive and resiliently reposition the teeth in accordance with a particular treatment stage.

In one embodiment, a sheet of material is pressure formed or thermoformed over the mold. The sheet may be, for example, a sheet of polymeric (e.g., an elastic thermopolymeric, a sheet of polymeric material, etc.). To thermoform the shell over the mold, the sheet of material may be heated to a temperature at which the sheet becomes pliable. Pressure may concurrently be applied to the sheet to form the now pliable sheet around the mold. Once the sheet cools, it will have a shape that conforms to the mold. In one embodiment, a release agent (e.g., a non-stick material) is applied to the mold before forming the shell. This may facilitate later removal of the mold from the shell. Forces may be applied to lift the appliance from the mold. In some instances, a breakage, warpage, or deformation may result from the removal forces. Accordingly, embodiments disclosed herein may determine where the probable point or points of damage may occur in a digital design of the appliance prior to manufacturing and may perform a corrective action.

Additional information may be added to the appliance. The additional information may be any information that pertains to the appliance. Examples of such additional information includes a part number identifier, patient name, a patient identifier, a case number, a sequence identifier (e.g., indicating which appliance a particular liner is in a treatment sequence), a date of manufacture, a clinician name, a logo and so forth. For example, after determining there is a probable point of damage in a digital design of an appliance, an indicator may be inserted into the digital design of the appliance. The indicator may represent a recommended place to begin removing the polymeric appliance to prevent the point of damage from manifesting during removal in some embodiments.

In some embodiments, a library of removal methods/patterns may be established and this library may be referenced when simulating the removal of the aligner in the numerical simulation. Different patients or production technicians may tend to remove aligners differently, and there might be a few typical patterns. For example: 1) some patients lift from the lingual side of posteriors first (first left and then right, or vice versa), and then go around the arch from left/right posterior section to the right/left posterior section; 2) similar to #1, but some other patients lift only one side of the posterior and then go around the arch; 3) similar to #1, but some patients lift from the buccal side rather than the lingual side of the posterior; 4) some patients lift from the anterior incisors and pull hard to remove the aligner; 5) some other patients grab both lingual and buccal side of a posterior location and pull out both sides at the same time; 6) some other patients grab a random tooth in the middle. The library can also include a removal guideline provided by the manufacturer of the aligner. Removal approach may also depend on presence or absence of attachments on teeth as some pf the above method may result in more comfortable way of removal. Based on the attachment situation on each tooth, it can be determined how each patient would probably remove an aligner and adapt that removal procedure for that patient in that specific simulation.

After an appliance is formed over a mold for a treatment stage, the appliance is removed from the mold (e.g., automated removal of the appliance from the mold), and the appliance is subsequently trimmed along a cutline (also referred to as a trim line). The processing logic may determine a cutline for the appliance. The determination of the cutline(s) may be made based on the virtual 3D model of the dental arch at a particular treatment stage, based on a virtual 3D model of the appliance to be formed over the dental arch, or a combination of a virtual 3D model of the dental arch and a virtual 3D model of the appliance. The location and shape of the cutline can be important to the functionality of the appliance (e.g., an ability of the appliance to apply desired forces to a patient's teeth) as well as the fit and comfort of the appliance. For shells such as orthodontic appliances, orthodontic retainers and orthodontic splints, the trimming of the shell may play a role in the efficacy of the shell for its intended purpose (e.g., aligning, retaining, or positioning one or more teeth of a patient) as well as the fit of the shell on a patient's dental arch. For example, if too much of the shell is trimmed, then the shell may lose rigidity and an ability of the shell to exert force on a patient's teeth may be compromised. When too much of the shell is trimmed, the shell may become weaker at that location and may be a point of damage when a patient removes the shell from their teeth or when the shell is removed from the mold. In some embodiments, the cut line may be modified in the digital design of the appliance as one of the corrective actions taken when a probable point of damage is determined to exist in the digital design of the appliance.

On the other hand, if too little of the shell is trimmed, then portions of the shell may impinge on a patient's gums and cause discomfort, swelling, and/or other dental issues. Additionally, if too little of the shell is trimmed at a location, then the shell may be too rigid at that location. In some embodiments, the cutline may be a straight line across the appliance at the gingival line, below the gingival line, or above the gingival line. In some embodiments, the cutline may be a gingival cutline that represents an interface between an appliance and a patient's gingiva. In such embodiments, the cutline controls a distance between an edge of the appliance and a gum line or gingival surface of a patient.

Each patient has a unique dental arch with unique gingiva. Accordingly, the shape and position of the cutline may be unique and customized for each patient and for each stage of treatment. For instance, the cutline is customized to follow along the gum line (also referred to as the gingival line). In some embodiments, the cutline may be away from the gum line in some regions and on the gum line in other regions. For example, it may be desirable in some instances for the cutline to be away from the gum line (e.g., not touching the gum) where the shell will touch a tooth and on the gum line (e.g., touching the gum) in the interproximal regions between teeth. Accordingly, it is important that the shell be trimmed along a predetermined cutline.

In some embodiments, the dental appliances (e.g., orthodontic appliances) herein (or portions thereof) can be produced using direct fabrication, such as additive manufacturing techniques (also referred to herein as “3D printing) or subtractive manufacturing techniques (e.g., milling). In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances 712, 714, and 716. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances 712, 714, and 716 can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances 712, 714, and 716 can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances 712, 714, and 716. In some embodiments, material jetting involves jetting or extruding one or more materials onto a build surface in order to form successive layers of the object geometry.

In some embodiments, the direct fabrication methods provided herein build up the object geometry in a layer-by-layer fashion, with successive layers being formed in discrete build steps. Alternatively or in combination, direct fabrication methods that allow for continuous build-up of an object geometry can be used, referred to herein as “continuous direct fabrication.” Various types of continuous direct fabrication methods can be used. As an example, in some embodiments, the appliances 712, 714, and 716 are fabricated using “continuous liquid interphase printing,” in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

The direct fabrication approaches provided herein are compatible with a wide variety of materials, including but not limited to one or more of the following: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, a thermoset material, or combinations thereof. The materials used for direct fabrication can be provided in an uncured form (e.g., as a liquid, resin, powder, etc.) and can be cured (e.g., by photopolymerization, light curing, gas curing, laser curing, crosslinking, etc.) in order to form an orthodontic appliance or a portion thereof. The properties of the material before curing may differ from the properties of the material after curing. Once cured, the materials herein can exhibit sufficient strength, stiffness, durability, biocompatibility, etc. for use in an orthodontic appliance. The post-curing properties of the materials used can be selected according to the desired properties for the corresponding portions of the appliance.

In some embodiments, relatively rigid portions of the orthodontic appliance can be formed via direct fabrication using one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and/or a polytrimethylene terephthalate.

In some embodiments, relatively elastic portions of the orthodontic appliance can be formed via direct fabrication using one or more of the following materials: a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, and/or a thermoplastic polyamide elastomer.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials from distinct material supply sources in order to fabricate an object from a plurality of different materials. Such methods are described in U.S. Pat. No. 6,749,414, the disclosure of which is incorporated herein by reference in its entirety. Alternatively or in combination, a multi-material direct fabrication method can involve forming an object from multiple materials in a plurality of sequential manufacturing steps. For instance, a first portion of the object can be formed from a first material in accordance with any of the direct fabrication methods herein, and then a second portion of the object can be formed from a second material in accordance with methods herein, and so on, until the entirety of the object has been formed.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 μm, or within a range from about 5 μm to about 50 μm, or within a range from about 20 μm to about 50 μm.

The direct fabrication techniques described herein can be used to produce appliances with substantially isotropic material properties, e.g., substantially the same or similar strengths along all directions. In some embodiments, the direct fabrication approaches herein permit production of an orthodontic appliance with a strength that varies by no more than about 25%, about 20%, about 15%, about 10%, about 5%, about 1%, or about 0.5% along all directions. Additionally, the direct fabrication approaches herein can be used to produce orthodontic appliances at a faster speed compared to other manufacturing techniques. In some embodiments, the direct fabrication approaches herein allow for production of an orthodontic appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1−x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated at the end of each build. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

In many embodiments, environmental variables (e.g., temperature, humidity, sunlight, or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

Once appliances (e.g., aligners) are directly fabricated, they may be inspected using the systems and/or methods described herein above.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled rapid prototyping such as 3D printing, etc.). The computer-based methods presented herein can improve the accuracy, flexibility, and convenience of appliance fabrication.

FIG. 7C illustrates a method 750 of orthodontic treatment using a plurality of appliances, in accordance with embodiments. One or more of the plurality of appliances may be formed using preliminary laser operations, post-processing laser operations, and/or calibration, as disclosed herein. The method 750 can be practiced using any of the appliances or appliance sets described herein. In block 760, a first orthodontic appliance is applied to a patient's teeth in order to reposition the teeth from a first tooth arrangement to a second tooth arrangement. In block 770, a second orthodontic appliance is applied to the patient's teeth in order to reposition the teeth from the second tooth arrangement to a third tooth arrangement. The method 750 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 8 illustrates a method 800 for designing an orthodontic appliance to be produced by direct fabrication, in accordance with embodiments. The method 800 can be applied to any embodiment of the orthodontic appliances that may be formed using preliminary laser operations, post-processing laser operations, and/or calibration, as disclosed herein. Some or all of the blocks of the method 800 can be performed by any suitable data processing system or device, e.g., one or more processors configured with suitable instructions.

In block 810, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 820, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients will typically require lower forces to expand the suture than older patients, as the suture has not yet fully formed.

In block 830, appliance design for an orthodontic appliance configured to produce the force system is determined. Determination of the orthodontic appliance, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA(Abaqus) software products from Dassault Systèmes of Waltham, MA.

Optionally, one or more orthodontic appliances can be selected for testing or force modeling. As noted above, a desired tooth movement, as well as a force system required or desired for eliciting the desired tooth movement, can be identified. Using the simulation environment, a candidate orthodontic appliance can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 840, instructions for fabrication of the orthodontic appliance incorporating the appliance design are generated. The instructions can be configured to control a fabrication system or device in order to produce the orthodontic appliance with the specified orthodontic appliance. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming. In some embodiments, the instructions for fabrication of the orthodontic appliance include instructions for performing preliminary laser operations, post-processing laser operations, and/or calibration, as disclosed herein.

Method 800 may include additional blocks: 1) The upper arch and palate of the patient is scanned intraorally to generate three-dimensional data of the palate and upper arch; and/or 2) The three-dimensional shape profile of the appliance is determined to provide a gap and teeth engagement structures as described herein.

Although the above blocks show a method 800 of designing an orthodontic appliance in accordance with some embodiments, a person of ordinary skill in the art will recognize some variations based on the teaching described herein. Some of the blocks may include sub-blocks. Some of the blocks may be repeated as often as desired. One or more blocks of the method 800 may be performed with any suitable fabrication system or device, such as the embodiments described herein. Some of the blocks may be optional, and the order of the blocks can be varied as desired.

FIG. 9 illustrates a method 900 for digitally planning an orthodontic treatment and/or design or fabrication of an appliance, in accordance with embodiments. The method 900 can be applied to any of the treatment procedures described herein and can be performed by any suitable data processing system.

In block 910, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 920, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 930, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired. The fabrication of the appliance may include preliminary laser operations, post-processing laser operations, and/or calibration, as disclosed herein.

In some instances, staging of various arrangements or treatment stages may not be necessary for design and/or fabrication of an appliance. As illustrated by the dashed line in FIG. 9, design and/or fabrication of an orthodontic appliance, and perhaps a particular orthodontic treatment, may include use of a representation of the patient's teeth (e.g., receive a digital representation of the patient's teeth at block 910), followed by design and/or fabrication of an orthodontic appliance based on a representation of the patient's teeth in the arrangement represented by the received representation.

It is to be understood that the above description is intended to be illustrative, and not restrictive. Many other embodiments will be apparent upon reading and understanding the above description. Although embodiments of the present disclosure have been described with reference to specific example embodiments, it will be recognized that the present disclosure is not limited to the embodiments described, but can be practiced with modification and alteration within the spirit and scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method comprising:
causing a sheet of plastic to be thermoformed over a mold to form a dental appliance associated with a dental arch of a user;
causing one or more preliminary laser operations to form a laser line in the dental appliance disposed on the mold; and
causing a one or more post-processing laser operations to smooth at least a portion of the laser line in the dental appliance disposed on the mold.

2. The method of claim 1, wherein the one or more preliminary laser operations comprise a cutting operation, and wherein the laser line comprises a gingival cut line of the dental appliance.

3. The method of claim 2, wherein the one or more preliminary laser operations comprise multiple passes of laser energy to cut through the dental appliance.

4. The method of claim 1, wherein the one or more preliminary laser operations comprise a marking operation, and wherein the laser line comprises an edge of a character marked in the dental appliance.

5. The method of claim 1, wherein the one or more preliminary laser operations comprise a bonding operation to bond an object with a shell of the dental appliance, and wherein the laser line comprises a bonding line.

6. The method of claim 1, wherein the one or more preliminary laser operations comprise one or more pulsing operations along the laser line to form a ridged profile.

7. The method of claim 1, wherein the one or more post-processing laser operations have a lower laser energy compared to the one or more preliminary laser operations.

8. The method of claim 1, wherein the one or more post-processing laser operations employ a modified laser focal length to reduce the peak power absorbed at the at least a portion of the laser line.

9. The method of claim 1, wherein the one or more post-processing laser operations have increased scanning speed with at least one of:
a larger beam area to re-scan the at least a portion of the laser line with lower transmitted power density compared to the one or more preliminary laser operations; or
a shorter duty cycle compared to the one or more preliminary laser operations.

10. The method of claim 1, wherein the one or more post-processing laser operations have decreased scanning speed with lower laser output to increase pulse-to-pulse overlap and reduce peak-to-peak amplitudes of ridges along the at least a portion of the laser line compared to the one or more preliminary laser operations.

11. The method of claim 1, wherein the one or more post-processing laser operations have offset pulses in phase to cause peak pulses to interact with the at least a portion of the laser line at an offset compared to the one or more preliminary laser operations to destructively interfere with a ridged profile along the at least a portion of the laser line.

12. The method of claim 1, wherein laser energy transmitted during the one or more post-processing laser operations are one or more of:
directly reduced to a lower laser power or a shorter duty cycle compared to the one or more preliminary laser operations; or
indirectly reduced via one or more of focus modification, targeting modification, or scanning rate modification compared to the one or more preliminary laser operations.

13. The method of claim 1, wherein the at least a portion of the laser line is one or more of a canine-premolar region of the laser line or high curvature regions of the laser line.

14. The method of claim 1 further comprising:
determining dental appliance data of the dental appliance;
providing the dental appliance data as input of a trained machine learning model;
receiving, from the trained machine learning model, output associated with predictive data; and
determining, based on the predictive data, laser operation data of one or more of the one or more preliminary laser operations or the one or more post-processing laser operations.

15. The method of claim 14, wherein the trained machine learning model is trained using input of historical dental appliance data and target output comprising historical laser operation data.

16. The method of claim 15, wherein the historical dental appliance data comprise historical images or three-dimensional topography data of historical dental appliances, wherein the historical laser operation data are associated with one or more of historical preliminary laser operations or historical post-processing laser operations.

17. A non-transitory machine-readable storage medium having instructions stored thereon, which, when executed by a processing device, cause the processing device to perform operations comprising:
causing a sheet of plastic to be thermoformed over a mold to form a dental appliance associated with a dental arch of a user;
causing one or more preliminary laser operations to form a laser line in the dental appliance disposed on the mold; and
causing a one or more post-processing laser operations to smooth at least a portion of the laser line in the dental appliance disposed on the mold.

18. A dental appliance laser operation system comprising:
a first laser head configured to cause one or more preliminary laser operations to form a laser line in a dental appliance, wherein the dental appliance is associated with a dental arch of a user; and
a second laser head configured to cause one or more post-processing laser operations to smooth at least a portion of the laser line in the dental appliance.

19. The dental appliance laser operation system of claim 18, wherein the first laser head is configured to cause the one or more preliminary laser operations at one or more first angles, and wherein the second laser head is configured to cause the one or more post-processing laser operations at one or more second angles that are different than the one or more first angles.

20. The dental appliance laser operation system of claim 18, wherein the first laser head has first dedicated energy output properties, and the second laser head has second dedicated energy output properties that are different from the first dedicated energy output properties, wherein the second laser head is configured to cause the one or more post-processing laser operations at one or more of a modified power output, modified focus, or modified wavelength compared to the one or more preliminary laser operations.

21. The dental appliance laser operation system of claim 18, wherein the first laser head has first dedicated energy output properties, and the second laser head has second dedicated energy output properties that are different from the first dedicated energy output properties, wherein the second laser head is configured to cause the one or more post-processing laser operations at a continuous wave.

22. The dental appliance laser operation system of claim 18, wherein the first laser head and the second laser head are configured to apply laser energy to the at least a portion of the laser line at opposing angles to alter cutline ridges to be a cross-hatched or three-dimensional ridged topography.

23-31. (canceled)
